(19) United States
(12) Patent Application Publication
(10) Pub. No.: US 2024/0420208 A1
(43) Pub. Date: Dec. 19, 2024

(54) SYSTEMS AND METHODS FOR ENHANCING ACCURACY OF CONVERSATIONAL INFORMATION RETRIEVAL FOR COMMERCE

(71) Applicant: BloomReach, Inc., Mountain View, CA (US)

(72) Inventors: Sebastián POLIAK, >Žilina (SK); Jan NOVÁCEK, Križíkova (CZ); Paul EDWARDS, Newdigate (GB); Irshad ALLANA, San Francisco, CA (US); Samit PAUL, Bengaluru (IN); Xun WANG, Houston, TX (US); Vikas JHA, Hillsborough, CA (US); Arun QAMRA, Santa Clara, CA (US)

(21) Appl. No.: 18/744,524

(22) Filed: Jun. 14, 2024

Related U.S. Application Data
(60) Provisional application No. 63/472,981, filed on Jun. 14, 2023.

(51) Int. Cl. G06Q 30/0601; G06F 16/332; G06F 40/134

(52) U.S. Cl. CPC G06Q 30/0627; G06F 16/3329; G06F 40/134; G06Q 30/0603

(57) ABSTRACT

Systems, methods, and apparatuses for customer engagement that receive a product catalog including information associated with a plurality of products; encode product data by at least one of generating a reverse text index associated with a plurality of products in the product catalog or vectorizing embeddings of the information associated with the plurality of products in the product catalog; store the encoded product data in a product catalog database; receive input from an end user; at least one of convert the end user input to a text query or create input vectors by vectorizing embeddings associated with the input; retrieve a list of products from the product catalog database based on at least one of the text query or the input vectors associated with the input; and output a response to the end user, wherein the response includes a link to information of products in the list of products.

### CROSS-REFERENCE TO RELATED APPLICATION

This application claims benefit of U.S. Provisional Patent Application No. 63/472,981 filed Jun. 14, 2023, which is hereby incorporated in its entirety.

### BACKGROUND OF THE INVENTION

### Field of the Invention

Embodiments of the present invention generally relate to systems and methods of enhancing accuracy of conversational information retrieval for commerce, and to the processing of natural language end user input related to commerce and generation of natural language and context-relevant responses to such end user input.

### Description of the Related Art

A large language model (LLM), is a deep learning algorithm that can recognize, summarize, translate, predict and generate text and other content based on knowledge gained from massive datasets. LLMs, such as the one that powers ChatGPT, are able to process natural language very effectively and are able to generate natural language and context-relevant responses to end user prompts (input). Such context-relevant responses is referred to as completion. The neural network used by some LLMs use fuzzy logic and may get confused about facts (e.g., “hallucinate”) resulting in returning inaccurate results to end users. When applied to an e-commerce use case, where an end user is looking for specific product details, such confusion or hallucination can hamper the search for the right (or even real) product.

Moreover, LLM's like ChatGPT are not bounded in the information that is returned to an end user. Thus, an end user looking for information for a product manufactured by one company or offered for sale by one company may receive product information from such LLM's that includes information about products from other manufacturers or sold by other companies.

### SUMMARY OF THE INVENTION

In some embodiments, a method of customer engagement includes: receiving a product catalog including information associated with a plurality of products; encoding product data by at least one of generating a reverse text index associated with a plurality of products in the product catalog or vectorizing embeddings of the information associated with the plurality of products in the product catalog; storing the encoded product data in a product catalog database; receiving input from an end user; at least one of converting the end user input to a text query or creating input vectors by vectorizing embeddings associated with the input; retrieving at least one list of products from the product catalog database based on at least one of the text query or the input vectors associated with the input; and outputting a response to the end user, wherein the response may include a selectable link to product information of products of the at least one list of products.

In some embodiments, a non-transitory computer readable medium, storing thereon computer readable instructions that when read by a computer cause a processor to perform a customer engagement method includes: receiving a product catalog including information associated with a plurality of products; encoding product data by at least one of generating a reverse text index associated with a plurality of products in the product catalog or vectorizing embeddings of the information associated with the plurality of products in the product catalog; storing the encoded product data in a product catalog database; receiving input from an end user; at least one of converting the end user input to a text query or creating input vectors by vectorizing embeddings associated with the input; retrieving at least one list of products from the product catalog database based on at least one of the text query or the input vectors associated with the input; and outputting a response to the end user, wherein the response includes a selectable link to product information of products of the at least one list of products.

In some embodiments, a system for customer engagement includes a processor configured to: receive a product catalog including information associated with a plurality of products; encode product data by at least one of generating a reverse text index associated with a plurality of products in the product catalog or vectorize embeddings of the information associated with the plurality of products in the product catalog; store the encoded product data in a product catalog database; receive input from an end user; at least one of convert the end user input to a text query or create input vectors by vectorizing embeddings associated with the input; retrieve at least one list of products from the product catalog database based on at least one of the text query or the input vectors associated with the input; and output a response to the end user, wherein the response includes a selectable link to product information of products of the at least one list of products.

In some embodiments, a non-transitory computer readable medium, storing thereon computer readable instructions that when read by a computer cause a processor to perform a customer engagement method comprising: receiving a product catalog including information associated with a plurality of products; creating product vectors by vectorizing embeddings or by generating a reverse index with meta data of the information associated with a plurality of products in the product catalog; storing the product vectors in a product vector database, storing the products in a standard index for text based look up; receiving input from an end user; creating input vectors by vectorizing embeddings associated with the input; retrieving at least one list of products from the product vector database, or a product reverse index database based on the input vectors associated with the input; and outputting a response to the end user, wherein the response includes a selectable link to product details information of products of the at least one list of products.

In some embodiments, a system for customer engagement includes: a processor configured to: receive a product catalog including information associated with a plurality of products; create product vectors by vectorizing embeddings of the information associated with a plurality of products in the product catalog, or creating a reverse index of the products; store the product vectors in a product vector database, or store the products in a reverse index database; receive input from an end user; creating input vectors by vectorizing embeddings associated with the input; retrieve at least one list of products from the product vector database based on the input vectors associated with the input; and output a response to the end user, wherein the response includes a selectable link to product details information of products of the at least one list of products.

In some embodiments, a method of customer engagement includes: receiving a product catalog; performing transforms on the product catalog; inputting the transforms into a large language model; receiving embeddings from the large language model; vectorizing the embeddings; storing vectors in a product vector database, or storing the products as a reverse indexes in a text search database; receiving input from an end user; retrieving embeddings from the input from the end user; vectorizing the embeddings associated with the input from the end user; inputting the vectors to the product vector database for product look up, or translating the input from the end user using LLM into a intent based text search query; retrieving at least one list of products from the product vector database; outputting the at least one list of products to the large language model; receiving a completion from the large language model; generating a response to the end user including product details of products of the at least one list of products; and outputting the response to the end user.

In some embodiments, a method of customer engagement includes: receiving input from an end user; receiving context related to the end user input that includes a chronologically ordered list of any preceding end user inputs or responses to preceding end user inputs, and one or more lists of products that were previously presented to the end user, viewed by the end user, added to a shopping cart by the end user, or selected by the end user; using a Large Language Model to understand the need described in the end user input and context related to the end user input and output the sequence of actions and parameters associated with the actions that will fulfill the need (Action Sequence Module); where each action in the sequence is selected by the LLM from a library of available action types; where each action type describes a method to perform a particular task, and the library of available action types includes, but is not limited to, an action type for selecting one or more products of interest referenced in the end user input or context related to the end user input (Selection), an action type for answering a question about one or more products (Product Expert), an action type for generating a response to the end user that includes questions to ask the end user to explain their need further (PreSearch), an action type for retrieving at least one list of products and information about those products based on a search query (Search), an action type for outputting a response to the end user that references at least one of the products in a list of products and may include a description of how at least one of the products addresses the end user's need (Search Result Explanation), an action type for outputting a response when the end user need is not about one or more products (Knowledge Expert) an action type for retrieving at least one list of products that are similar to one or more products and information about each of the retrieved products (Similar Products), an action type for retrieving at least one list of products that are related in a given way to one or more products.

In some embodiments, a method of customer engagement includes: receiving input from an end user; receiving context related to the end user input that includes a chronologically ordered list of any preceding end user inputs or responses to preceding end user inputs, and one or more lists of products that were previously presented to the end user, viewed by the end user, added to a shopping cart by the end user, or selected by the end user; receiving one or more product-related questions; receiving a list of products that the product-related questions reference and information about those products; outputting some or all of the above end user input, context, questions, referenced products and their information to a Large Language Model, and receiving a completion from the Large Language model; generating a response to the end user that answers the questions by including information about the referenced products; and outputting the response to the end user.

In some embodiments, a method of customer engagement includes: receiving a library of content; transforming the library into a catalog of content files; inputting each file into a large language model; receiving embeddings from the large language model; vectorizing the embeddings; storing vectors in a content vector database; receiving one or more questions; retrieving embeddings for the questions; vectorizing the embeddings associated with the questions; inputting the vectors to the content vector database for content look up; retrieving one or more retrieved content files from the content vector database; outputting questions and retrieved content files to a Large Language Model, and receiving a completion from the Large Language model; generating a response to the end user that answers the questions; and outputting the response to the end user.

In some embodiments, a method of customer engagement includes: receiving input from an end user; receiving context related to the end user input that includes a chronologically ordered list of any preceding end user inputs or responses to preceding end user inputs, and one or more lists of products that were previously presented to the end user, viewed by the end user, added to a shopping cart by the end user, or selected by the end user; receiving a search query for products; receiving an ordered list of products that match the search query; outputting some or all of the above end user input, context, search query and ordered list of products to a Large Language Model, and receiving a completion from the Large Language model that transforms the ordered product list into a new ordered list of products where the order of a product in the list corresponds to the relevance of the product to the search query.

In some embodiments, a method of customer engagement includes: receiving search query from an end user; outputting the query and the categories values, attributes name, attribute description, and attribute values in the relevant catalog to a Large Language Model, and receiving completions from the Large Language model that generate a structured search query that includes filtering expression, relevant attribute values, and sorting instruction.

In some embodiments, a method of customer engagement includes: receiving search query from the end user; outputting the search query, the conversation context, product catalog info, and merchant info to a Large Language Model, and receiving a completion that determines if enough information is available to search for relevant products to show to the end user. If it is determined that not enough information is available to search for relevant products to show to the end user, then an appropriate question is generated to ask the end user to guide them to provide more such information about what kind of products they are looking for.

In some embodiments, a method of customer engagement includes: receiving search query from the end user; responding with products relevant to the search query and all available context; outputting the conversation context, the relevant products (shown) along with all their attribute info to a Large Language Model, and receiving a completion that generates relevant questions to ask the user in order to further refine the list of products shown to the end user in response to their search inquiry.

In some embodiments, a method of customer engagement includes: receiving search query from the end user; responding with products relevant to the search query and all available context; outputting the conversation context, the relevant products (shown) along with all their attribute info to a Large Language Model, and receiving a completion that generates relevant explanations to show to the end user in order to explain the reasoning of why the shown product results were shown to the end user.

In some embodiments, a method of customer engagement includes: receiving user input from an end user; if it is determined that the end user is seeking to ask certain questions about certain products from their context, and then outputting the user input and products in context to a Large Language Model, and receiving a completion that determines which product(s) the end user is intending to ask their questions about.

In some embodiments, a method of customer engagement includes: receiving a search query from an end user; if it is determined that the end user is seeking to search for products that are related to one or more of the previously selected products in end user's context, that are related either in a general way, or in some specific way(s) e.g. price, color, shape, complementary, accessory etc., then using the search query, selected products, and an embeddings based vector search on the available product catalog, and possibly an LLM model, to determine the relevant products to show to the end user.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a high-level block diagram of an embodiment of a network architecture of a system for customer engagement in accordance with the present principles.

FIG. 2A depicts a block diagram of the network architecture of FIG. 1 along with data flow.

FIG. 2B depicts elements of the block diagram in FIG. 2B with a workflow in accordance with the present principles.

FIGS. 3A-3C depict a flow diagram of a method for customer engagement, in accordance with the present principles.

FIG. 4 depicts an example interaction between an end user device and a central server in accordance with the present principles.

FIG. 5 depicts a modified block diagram to that of FIG. 2A along with data flow.

FIG. 6 depicts a flow diagram of a method for customer engagement, in accordance with the present principles.

FIG. 7 depicts a high-level block diagram of a computing device suitable for use with embodiments for customer engagement in accordance with the present principles.

FIGS. 8 and 9 depict a method in accordance with some embodiments of the present disclosure.

FIGS. 10 and 11 depict an example of the method of FIG. 8.

FIG. 12 depicts a method in accordance with some embodiments of the present disclosure.

FIG. 13 depicts an example of the method of FIG. 12.

FIG. 14 depicts a method in accordance with some embodiments of the present disclosure.

FIG. 15 depicts an example of the method of FIG. 14.

FIG. 16 depicts a method in accordance with some embodiments of the present disclosure.

FIG. 17 depicts a method in accordance with some embodiments of the present disclosure.

FIG. 18 depicts an example of the method of FIG. 17.

FIG. 19 depicts a method in accordance with some embodiments of the present disclosure.

FIG. 20 depicts an example of the method of FIG. 19.

FIG. 21 depicts a method in accordance with some embodiments of the present disclosure.

FIG. 22 depicts an example of the method of FIG. 21.

FIG. 23 depicts a method in accordance with some embodiments of the present disclosure.

FIGS. 24 and 25 depict examples of the method of FIG. 23.

FIGS. 26A-26C depict a method in accordance with some embodiments of the present disclosure.

FIG. 27 depicts a method in accordance with some embodiments of the present disclosure.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

The following detailed description describes techniques (e.g., methods, processes, and systems) for customer engagement. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims.

Embodiments consistent with the disclosure provide an interface for e-commerce businesses to send their product catalog into a retrieval augmentation database, and then merge that with large language models to look up and generate the factual information back to the end user about products.

Systems and method in accordance with this disclosure can receive (e.g., from an e-commerce server associated with an e-commerce business, e.g., retailer), a product catalog (e.g., at an API endpoint), accept the product catalog, perform transforms on the product catalog, feed the transforms into an LLM to generate embeddings, and encode product data by at least one of generating a reverse text index associated with a plurality of products in the product catalog or by vectorizing embeddings of the information associated with the plurality of products in the product catalog; and store the encoded product data in a Product Catalog Database (PCD). In addition, systems and method in accordance with this disclosure can receive input (e.g., prompt text) from an end user (e.g., customer of the e-commerce business) through another API endpoint, call on the large language model to retrieve embeddings from the end user input, at least one of vectorize the embeddings associated with the end user input or convert the end user input to a text query, send at least one of the vectors or text query to the PCD for look up, retrieve at least one list of products relevant to at least one of the vectors or text query, and output to the LLM for completion to generate a response (e.g., text) to the end user. The systems and methods may utilize prompt engineering to limit the response to include product information from the product catalog. Thus, in some embodiments, the prompt text from an end user may also include predetermined elements that configure the systems and methods to only include products in the response from the list of products in the product catalog and only if the products are relevant to a context of the prompt text.

The systems and method in accordance with the disclosure facilitate conversational commerce and conversion by allowing customers to find and purchase a real in-stock product. Also, the systems and methods in accordance with the disclosure can enhance existing large language models to be factually correct with respect to products and catalogs, and may reduce “hallucinations” by using accurate long term memory vector database that stores accurate product information, and correct up to date URL to be able to purchase the product. Also, the systems and methods in accordance with the disclosure may regenerate a natural language conversational type response using the combination of large language model completion capabilities.

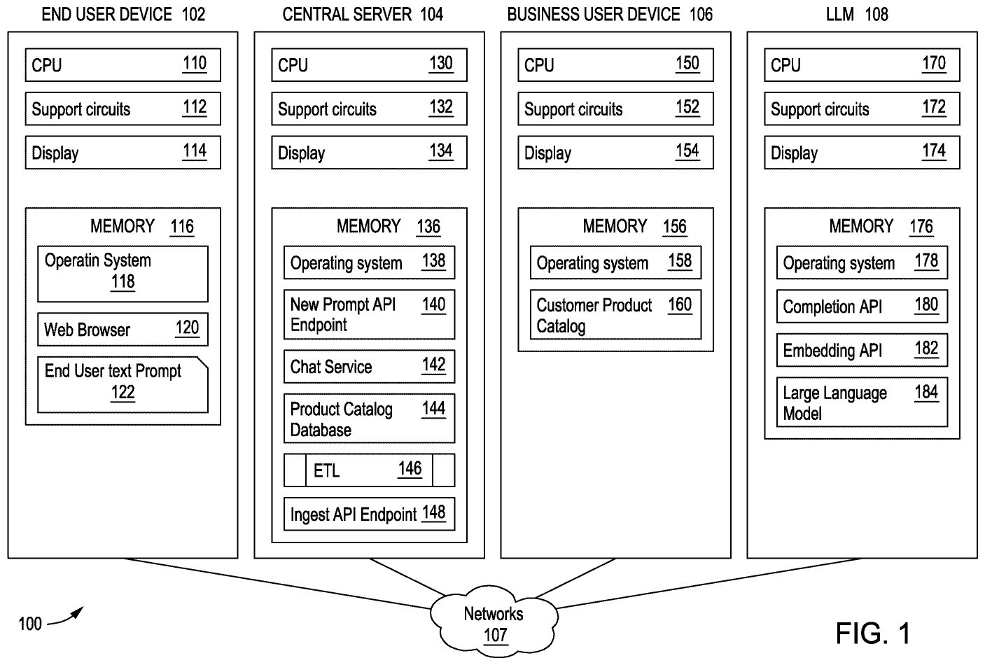

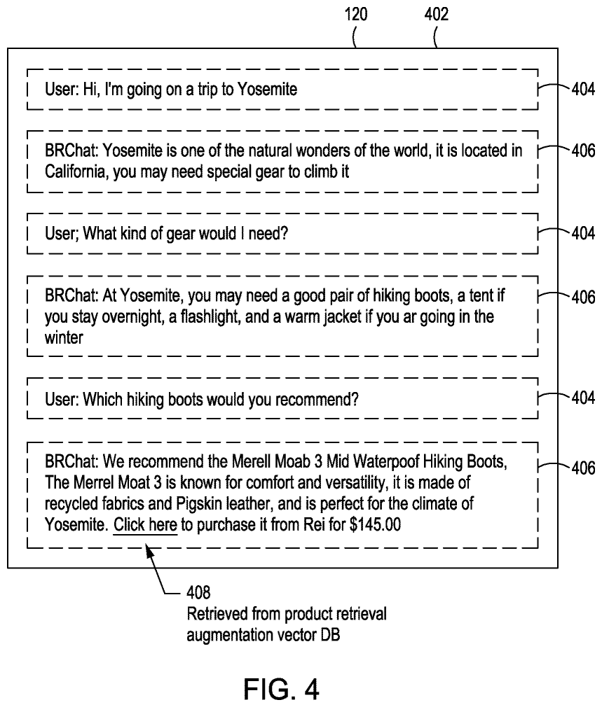

FIG. 1 depicts a block diagram of a system for customer engagement 100 in accordance with at least one embodiment of the disclosure. The system 100 includes a plurality of end user devices 102 (one is shown in FIG. 1), a central server 104, a plurality of business user (e.g., retailer) devices 106 (one is shown in FIG. 1), and a plurality of LLMs 108 (one is shown in FIG. 1) communicatively coupled via one or more networks 107 (one is shown in FIG. 1). In embodiments, the central server 104 is configured to communicate with the end user devices 102 and business user devices 106 via networks 107 as discussed in greater detail below. FIG. 4 depicts a computer system 400 that can be utilized in various embodiments of the invention to implement at least one or more of the end user devices 102, central server 104, business user devices 106, or LLMs 108, according to one or more embodiments.

The networks 107 comprise one or more communication systems that connect computers by wire, cable, fiber optic, and/or wireless link facilitated by various types of well-known network elements, such as hubs, switches, routers, and the like. The networks 107 may include an Internet Protocol (IP) network, a public switched telephone network (PSTN), or other mobile communication networks, and may employ various well-known protocols to communicate information amongst the network resources.

The end user devices 102 comprises a Central Processing Unit (CPU) 110, support circuits 112, display device 114, and memory 116. The CPU 110 may comprise one or more commercially available microprocessors or microcontrollers that facilitate data processing and storage. The various support circuits 112 facilitate the operation of the CPU 110 and include one or more clock circuits, power supplies, cache, input/output circuits, and the like. The memory 116 comprises at least one of Read Only Memory (ROM), Random Access Memory (RAM), disk drive storage, optical storage, removable storage and/or the like. In some embodiments, the memory 116 comprises an operating system 118, and a web browser 120. The memory 116 may also include an end user text prompt service which allows an end user to input prompts, such as text for interaction with the system 100. In some embodiments, the web browser 120 may be used as an interface for the text prompt service.

The operating system (OS) 118 generally manages various computer resources (e.g., network resources, file processors, and/or the like). The operating system 118 is configured to execute operations on one or more hardware and/or software modules, such as Network Interface Cards (NICs), hard disks, virtualization layers, firewalls and/or the like. Examples of the operating system 118 may include, but are not limited to, various versions of LINUX, MAC OSX, BSD, UNIX, MICROSOFT WINDOWS, IOS, ANDROID and the like.

The web browser 120 is a well-known application for accessing and displaying web page content. Such browsers include, but are not limited to, Safari®, Chrome®, Explorer®, Firefox®, etc. End user text prompts as well as any other end user input may be input to end user devices 102 using the web browser 120. The end user devices 102 may send such end user input to the central server 104 to elicit responses that may be returned to the end user through the web browser 120 as described in greater detail below. This may be performed by multiple end user devices 102 continuously as the end users interact with the end user devices 102.

In some embodiments, and as shown in FIG. 1, the centralized server 104 may comprise a Central Processing Unit (CPU) 130, support circuits 132, a display device 134, and memory 136. The CPU 130 may comprise one or more commercially available microprocessors or microcontrollers that facilitate data processing and storage. The various support circuits 132 facilitate the operation of the CPU 130 and include one or more clock circuits, power supplies, cache, input/output circuits, and the like. The memory 136 comprises at least one of Read Only Memory (ROM), Random Access Memory (RAM), disk drive storage, optical storage, removable storage and/or the like. In some embodiments, the memory 136 comprises an operating system 138. In some embodiments, the memory 136 includes a new prompt API endpoint 140, a chat service 142, a product catalog database (PCD) 144, an extract, transform, load (ETL) module 146, and an ingest API endpoint 148.

The ingest API endpoint 148 is configured to receive a customer product catalog 160 and pass it to the ETL module 146. The ETL module 146 is configured to perform transforms on the product catalog, feed the transforms into the LLM (which generates embeddings based on the content of the product catalog), receive the embeddings for each product description from the LLM, create product vectors by vectorizing the embeddings of the information associated with each product in the product catalog, and store the vectors in the PCD 144. More specifically, in some embodiments, the ETL module 146 is configured to transform the product catalog 160 into natural language and feed the natural language into the LLM. Vectorizing includes generating a number (e.g., a vector) based on the embeddings. Such number or vector can be stored in the PCD 144 for retrieval_{[CM1]}.

The new prompt API endpoint 140 is configured to receive end user input, such as text input via the end user text prompt 122 or web browser 120. The chat service 142 is configured to send end user input to the LLM and receive embeddings of the end user input from the LLM. The chat service 142 is configured to create input vectors by vectorizing the embeddings associated with the end user input. Also, the chat service 142 is configured to send requests to the PCD 144 and receive a product listing from the PCD144. The chat service 142 is also configured to send the received product listing to the LLM and receive a completion from the LLM. The chat service 142 can also output a response with factually correct product information, such as including a selectable link to product information, to the end user via the new prompt API end point 140. The product information can be limited to products cataloged in the customer product catalog 160.

In some embodiments, and as shown in FIG. 1, the business user device 106 may comprise a Central Processing Unit (CPU) 150, support circuits 152, a display device 154, and memory 156. The CPU 150 may comprise one or more commercially available microprocessors or microcontrollers that facilitate data processing and storage. The various support circuits 152 facilitate the operation of the CPU 150 and include one or more clock circuits, power supplies, cache, input/output circuits, and the like. The memory 156 comprises at least one of Read Only Memory (ROM), Random Access Memory (RAM), disk drive storage, optical storage, removable storage and/or the like. In some embodiments, the memory 156 comprises an operating system 158. In some embodiments, the memory 156 includes a customer product catalog 160. The customer product catalog 160 includes product descriptions of products included in customer product catalog 160.

In some embodiments, and as shown in FIG. 1, the LLM 108 may comprise a Central Processing Unit (CPU) 170, support circuits 172, a display device 174, and memory 176. The CPU 170 may comprise one or more commercially available microprocessors or microcontrollers that facilitate data processing and storage. The various support circuits 172 facilitate the operation of the CPU 170 and include one or more clock circuits, power supplies, cache, input/output circuits, and the like. The memory 176 comprises at least one of Read Only Memory (ROM), Random Access Memory (RAM), disk drive storage, optical storage, removable storage and/or the like. In some embodiments, the memory 176 comprises an operating system 178. In some embodiments, the memory 176 includes a completion API 180, an embedding API 182, and an LLM 184.

The LLM 184 and the embedding API 182 are configured to generate embeddings from end user input. The LLM 184 and the completion API 180 are configured to generate a response to an end user in response to the end user input. Any LLM may be used, including OpenAI and BERT (Bidirectional Encoder Representations from Transformers).

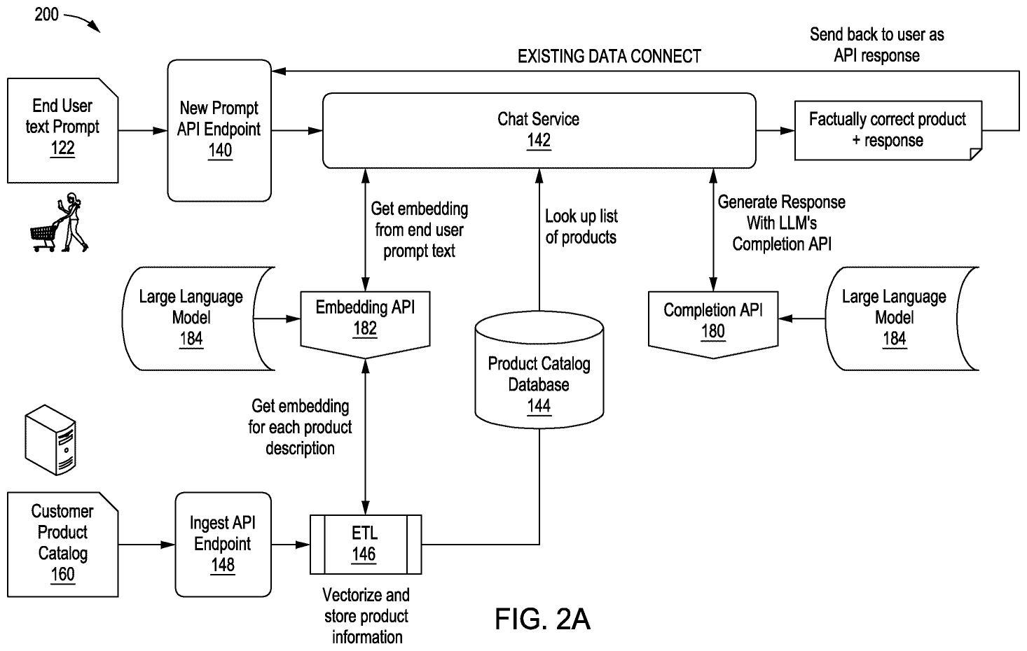

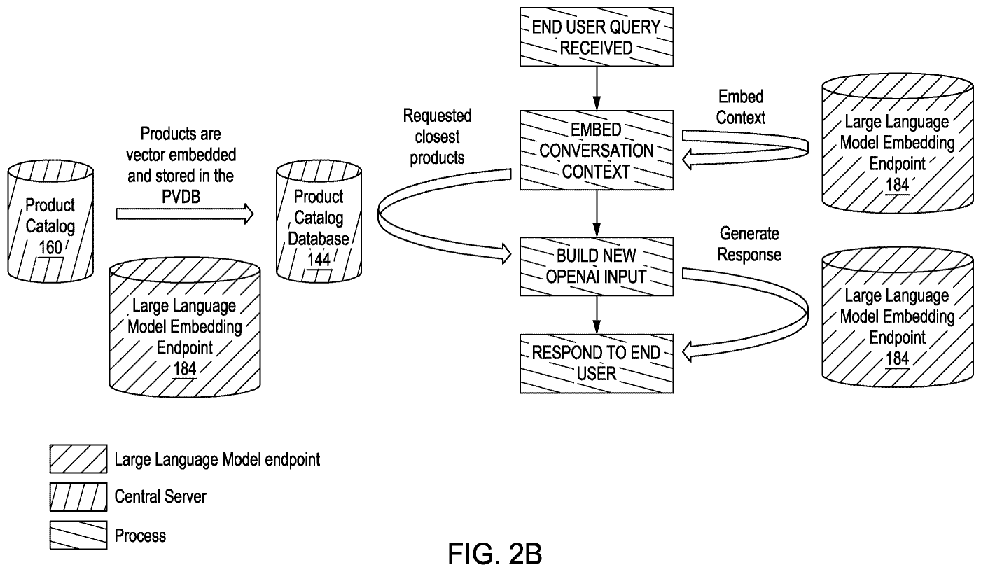

FIGS. 2A and 2B show a flow of information through the system 100. As shown in FIG. 2B, a product catalog is received and products are vector embedded using LLM 184 and stored in PCD 144. More specifically, as shown in FIG. 2A, the ingest API endpoint 148 receives the product catalog 160, the ETL 146 performs a transform on the product catalog 160 and feeds the transforms to the embedding API 182 and the LLM 184. Also, as shown in FIG. 2A, the LLM 184 generates embeddings and returns them to the ETL 146 via the embedding API 182. The ETL 146 creates product vectors by vectorizing the embeddings of the information associated with the products in the product catalog 160 and the product vectors are stored in PCD 144.

As shown in FIG. 2B, an end user input (e.g., a query) is received. For example, as shown in FIG. 2A, an end user input is received, such as by new prompt API endpoint 140. Also, as shown in FIG. 2B, conversation text from the end user input is embedded using LLM 184. For example, as shown in FIG. 2A, end user input is passed to chat service 142 that uses LLM 184 and embedding API 182 to obtain embeddings from end user input. Also, as shown in FIG. 2B, products that are relevant to the conversation text are requested from the PCD 144. For example, as shown in FIG. 2A, chat service 142 may create input vectors by vectorizing the embeddings and look up the vectors in the PCD 144. As shown in FIG. 2B, products are retrieved from the PCD 144 and returned to build a new input for the LLM (e.g., an OpenAI input). The new input is passed to LLM 184 to generate a response to the end user that includes product information. For example, as shown in FIG. 2A, chat service 142 may send a list of products (e.g., as a selectable link) retrieved from PCD144 to the completion API 180 and LLM 184 to generate a completion that is returned to the chat service 142 and output to the end user via the new prompt API endpoint 140.

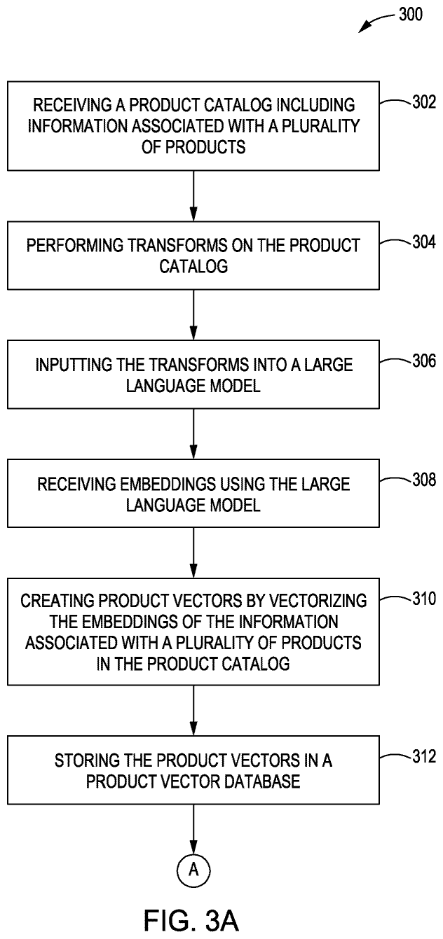

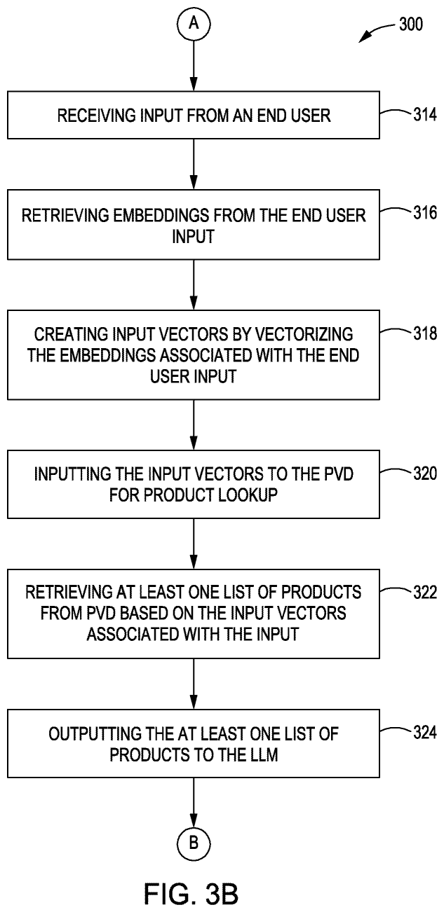

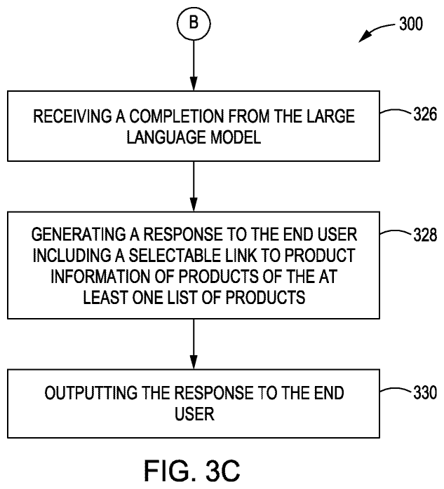

FIGS. 3A-3C show a method of customer engagement using the system 100. As shown in FIG. 3A, at 302, a product catalog is received, such as from the business user device 106. At 304, a transform of the product catalog is performed. Also, at 306, the transforms are fed into an LLM. At 308, embeddings for each product description are generated. At 310, product vectors are created by vectorizing the embeddings of the information associated with a plurality of products in the product catalog. At 312, the product vectors are stored in a PVD.

As shown in FIG. 3B, the method may also include at 314, receiving input (e.g., an input prompt) from an end user. At 316, embeddings from the end user input are retrieved, such as from an LLM. At 318, input vectors are created by vectorizing the embeddings associated with the end user input. At 320, the input vectors are input to the PVD for product lookup. At 322, at least one list of products is retrieved from the PCD 144 based on the input vectors associated with the input. The retrieved products are part of a recall set that are determined to be contextually relevant to the end user input. At 324, the list of products (a recall set) is output to the LLM.

The recall set 324 may be limited to a certain number of products to speed up processing by the LLM. In some embodiments, a threshold limit of relevance may be set and used to exclude products from the recall set. For example, the threshold limit may be a measure of relevance to the context of the end user text input. Thus, in some embodiments, products that are below the threshold limit of relevance are not included in the recall set, whereas products that are above the threshold limit of relevance are included in the recall set.

As shown in FIG. 3C, at 326, a completion is received from the LLM. At 328, response to the end user is generated. The response includes product details of products of the at least one list of products. At 330, the response is output to the end user.

FIG. 4 shows an example of an interaction between the end user device 102 and the central server 104 using chat service 142. As shown in FIG. 4, the interaction may take place within a window 402 of a web browser 120 on an end user device 102. As shown in FIG. 4, the end user may input one or more prompts 402. Such prompts 402 may be typed or otherwise input into the window 402 by any other means, such as speech-to-text. After each prompt from the end user, the central server 104 returns a contextually relevant response 406, that may or may not include product information including a selectable link 408 to product information. At the end of the example interaction, the central server 104 returns a response that includes a selectable link 408 to product information that is contextually relevant to the conversation up to that point, where the conversation consists of the prompts 404 and the responses 406. The product information is derived only from product catalogs that are ingested and vectorized in the PCD 144. While the product information is limited to being only from the ingested catalogs, the other information in the responses to the end user are not under the control of the central server 104, but instead depend on the artificial intelligence algorithms and learning of the LLMs 108.

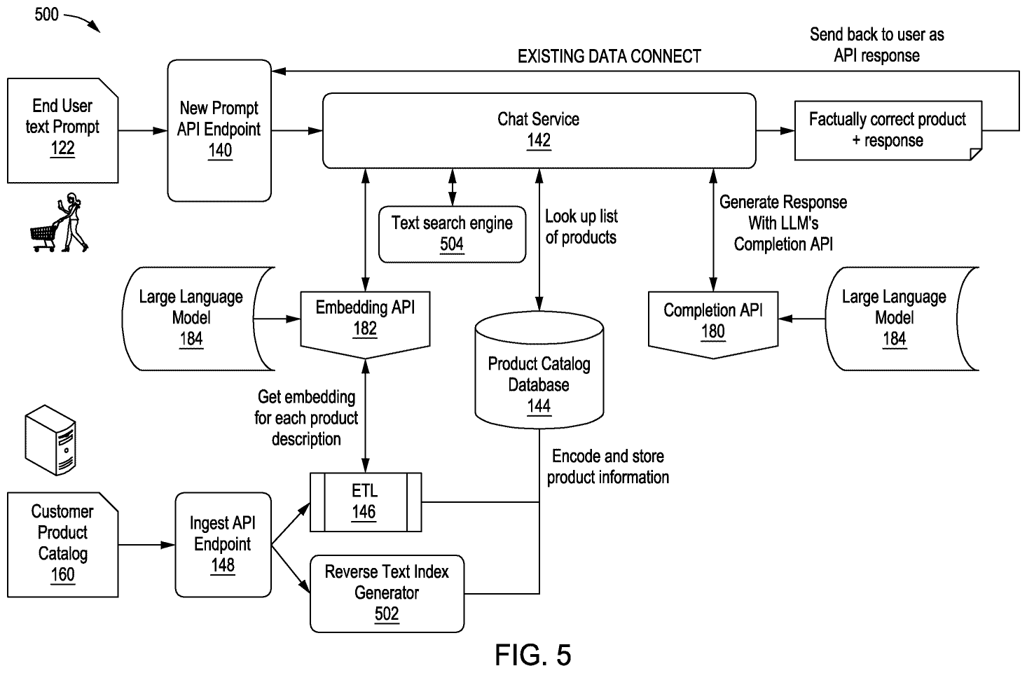

FIG. 5 shows a flow of information through a system 500, which is similar to system 100 with the exception of the differences noted below. In some embodiments, and as shown in FIG. 5, in addition to or as an alternative to the ETL 146 creating product vectors, in the embodiment shown in FIG. 5, a reverse text index generator 502 may generate a reverse text index of products in the product catalog 160. The reverse text index may include meta data of the information associated with a plurality of products in the product catalog. At least one of the product vectors or the reverse text index are stored in PCD 144.

In some embodiments, and as shown in FIG. 5, in addition to or as alternative to the product vectors returned to the chat service 142 by the embedding API 182, a text search engine 604 may convert text in text prompts into one or more text queries to query the reverse text index stored in PCD 144.

At least one list of products is retrieved from the PCD 144 based on at least one of the text search or input vectors associated with the input. Thus, in embodiments where both a text search and input vectors are used as search inputs to the PCD144, at least two lists of products will be retrieved from the PCD 144: a first list corresponding to the text search; and a second list corresponding to the input vectors. In such embodiments, to arrive at a single recall set to pass to the LLM 184, the first and second lists are compared to each other and any discrepancies between the two lists are evaluated to determine whether the discrepant list entries are to be included in the recall set. In some embodiments, a relevance weighting may be assigned (e.g., automatically using an algorithm) to any discrepant list entries. In some embodiments, any discrepant list entries having a weighting above a predetermined threshold may be included in the recall set, while any discrepant list entries having a weighting below the predetermined threshold may not be included in the recall set. The recall set may then be output to the LLM 184 to generate the completion using the completion API 180 as described above.

Also, in embodiments where only a text search is used as a search input to the PCD144, the list of products returned from the PCD144 will correspond only to the text search. Similarly, in embodiments where only input vectors are used as search inputs to the PCD144, the list of products returned from the PCT144 will correspond only to the input vectors.

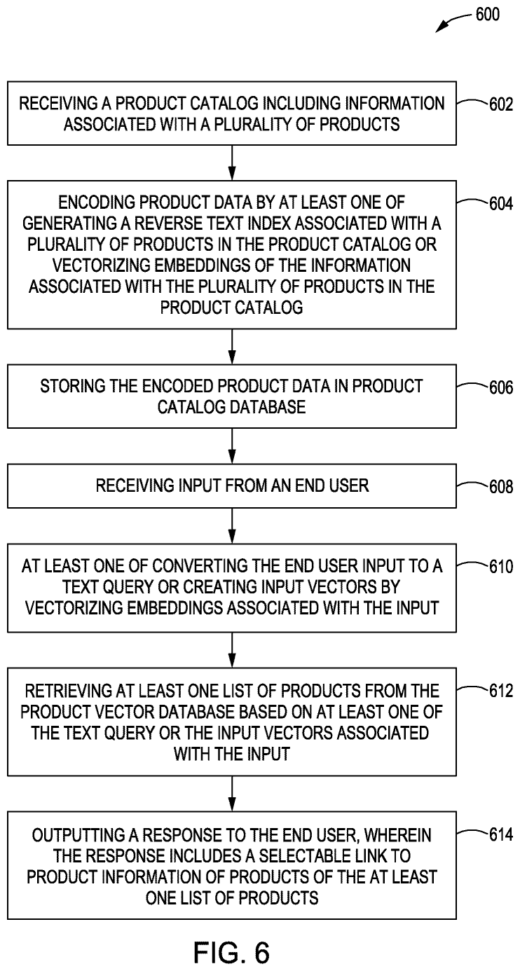

FIG. 6 shows a method 600 in accordance with embodiments of the disclosure. As shown in FIG. 6, at 602, a product catalog is received. The product catalog includes information associated with a plurality of products. At 604, product data is encoded by at least one of generating a reverse text index associated with a plurality of products in the product catalog or vectorizing embeddings of the information associated with the plurality of products in the product catalog. At 606, the encoded product data is stored in a product catalog database. At 608, input is received from an end user. At 610, at least one of the end user input is converted to a text query or input vectors are created by vectorizing embeddings associated with the input. At 612, at least one list of products is retrieved from the product vector database based on at least one of the text query or the input vectors associated with the input. At 614, a response is output to the end user. The response may include a selectable link to product information of products of the at least one list of products.

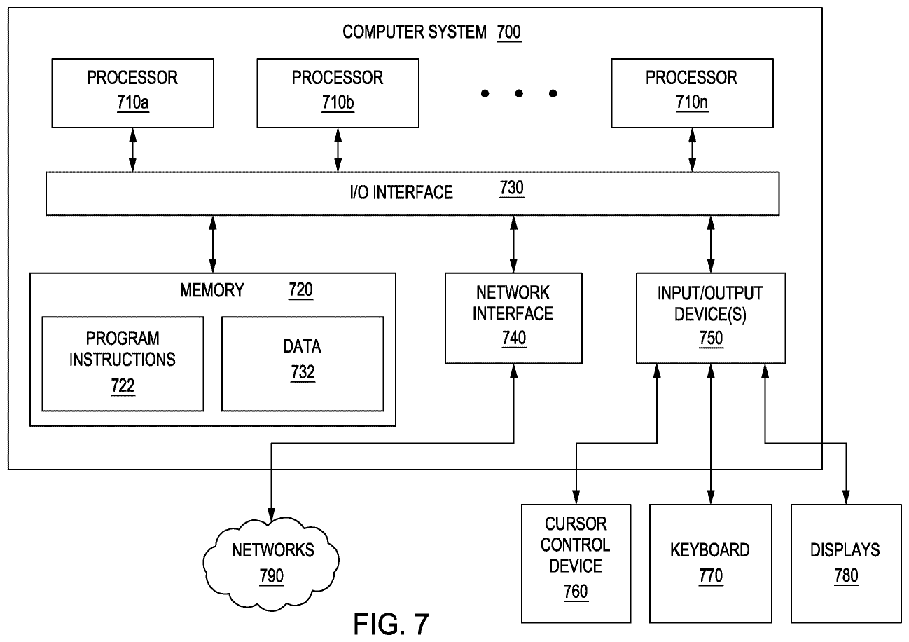

Various embodiments of method and system for customer engagement, as described herein, may be executed on one or more computer systems, which may interact with various other devices. One such computer system is computer system 700 illustrated by FIG. 7, which may in various embodiments implement any of the elements or functionality illustrated in FIGS. 1-6. In various embodiments, computer system 700 may be configured to implement methods described above. The computer system 700 may be used to implement any other system, device, element, functionality, or method of the above-described embodiments. In the illustrated embodiments, computer system 700 may be configured to implement the methods 300 and 500 as processor-executable executable program instructions 822 (e.g., program instructions executable by processor(s) 710) in various embodiments.

In the illustrated embodiment, computer system 700 includes one or more processors 710a-710n coupled to a system memory 720 via an input/output (I/O) interface 730. Computer system 700 further includes a network interface 740 coupled to I/O interface 730, and one or more input/output devices 750, such as cursor control device 760, keyboard 770, and display(s) 780. In various embodiments, any of the components may be utilized by the system to receive end user input described above. In various embodiments, a end user interface may be generated and displayed on display 780. In some cases, it is contemplated that embodiments may be implemented using a single instance of computer system 700, while in other embodiments multiple such systems, or multiple nodes making up computer system 700, may be configured to host different portions or instances of various embodiments. For example, in one embodiment some elements may be implemented via one or more nodes of computer system 700 that are distinct from those nodes implementing other elements. In another example, multiple nodes may implement computer system 700 in a distributed manner.

In different embodiments, computer system 700 may be any of various types of devices, including, but not limited to, a personal computer system, desktop computer, laptop, notebook, tablet or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 700 may be a uniprocessor system including one processor 710, or a multiprocessor system including several processors 710 (e.g., two, four, eight, or another suitable number). Processors 710 may be any suitable processor capable of executing instructions. For example, in various embodiments processors 710 may be general-purpose or embedded processors implementing any of a variety of instruction set architectures (ISAs). In multiprocessor systems, each of processors 710 may commonly, but not necessarily, implement the same ISA.

System memory 720 may be configured to store program instructions 722 and/or data 732 accessible by processor 710. In various embodiments, system memory 720 may be implemented using any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 720. In other embodiments, program instructions and/or data may be received, sent or stored upon different types of computer-accessible media or on similar media separate from system memory 720 or computer system 700.

In one embodiment, I/O interface 730 may be configured to coordinate I/O traffic between processor 710, system memory 720, and any peripheral devices in the device, including network interface 740 or other peripheral interfaces, such as input/output devices 750. In some embodiments, I/O interface 730 may perform any necessary protocol, timing or other data transformations to convert data signals from one component (e.g., system memory 720) into a format suitable for use by another component (e.g., processor 710). In some embodiments, I/O interface 730 may include support for devices attached through various types of peripheral buses, such as a variant of the Peripheral Component Interconnect (PCI) bus standard or the Universal Serial Bus (USB) standard, for example. In some embodiments, the function of I/O interface 730 may be split into two or more separate components, such as a north bridge and a south bridge, for example. Also, in some embodiments some or all of the functionality of I/O interface 730, such as an interface to system memory 720, may be incorporated directly into processor 710.

Network interface 740 may be configured to allow data to be exchanged between computer system 700 and other devices attached to a network (e.g., network 790), such as one or more external systems or between nodes of computer system 700. In various embodiments, network 790 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 740 may support communication via wired or wireless general data networks, such as any suitable type of Ethernet network, for example; via digital fiber communications networks; via storage area networks such as Fiber Channel SANs, or via any other suitable type of network and/or protocol.

Input/output devices 750 may, in some embodiments, include one or more display terminals, keyboards, keypads, touchpads, scanning devices, voice or optical recognition devices, or any other devices suitable for entering or accessing data by one or more computer systems 700. Multiple input/output devices 750 may be present in computer system 700 or may be distributed on various nodes of computer system 700. In some embodiments, similar input/output devices may be separate from computer system 700 and may interact with one or more nodes of computer system 700 through a wired or wireless connection, such as over network interface 740.

In some embodiments, the illustrated computer system 700 may implement any of the operations and methods described above, such as the methods 300 and 500 illustrated by the flowcharts of FIGS. 3A-3C and 6. In other embodiments, different elements and data may be included.

Those skilled in the art will appreciate that computer system 700 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 700 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 700 may be transmitted to computer system 700 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

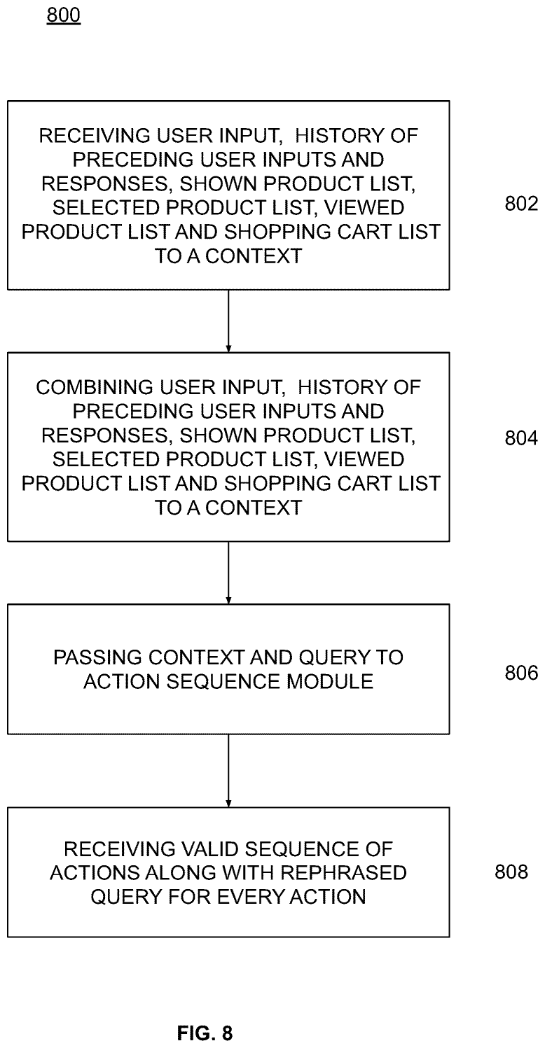

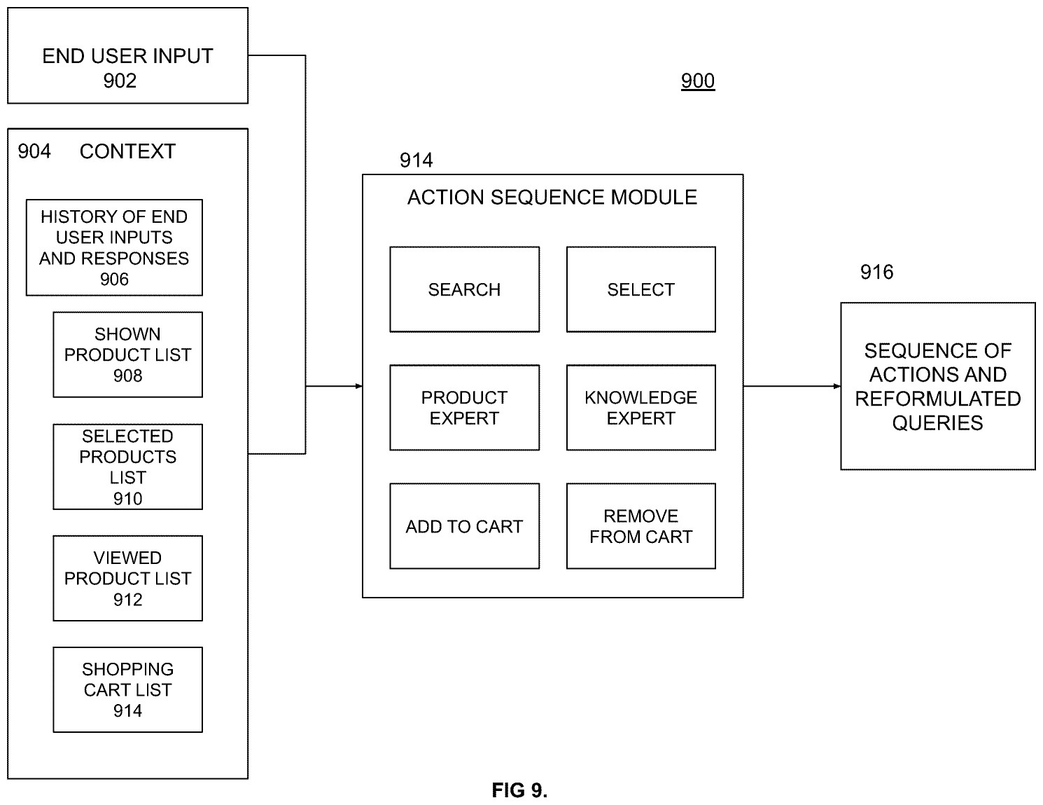

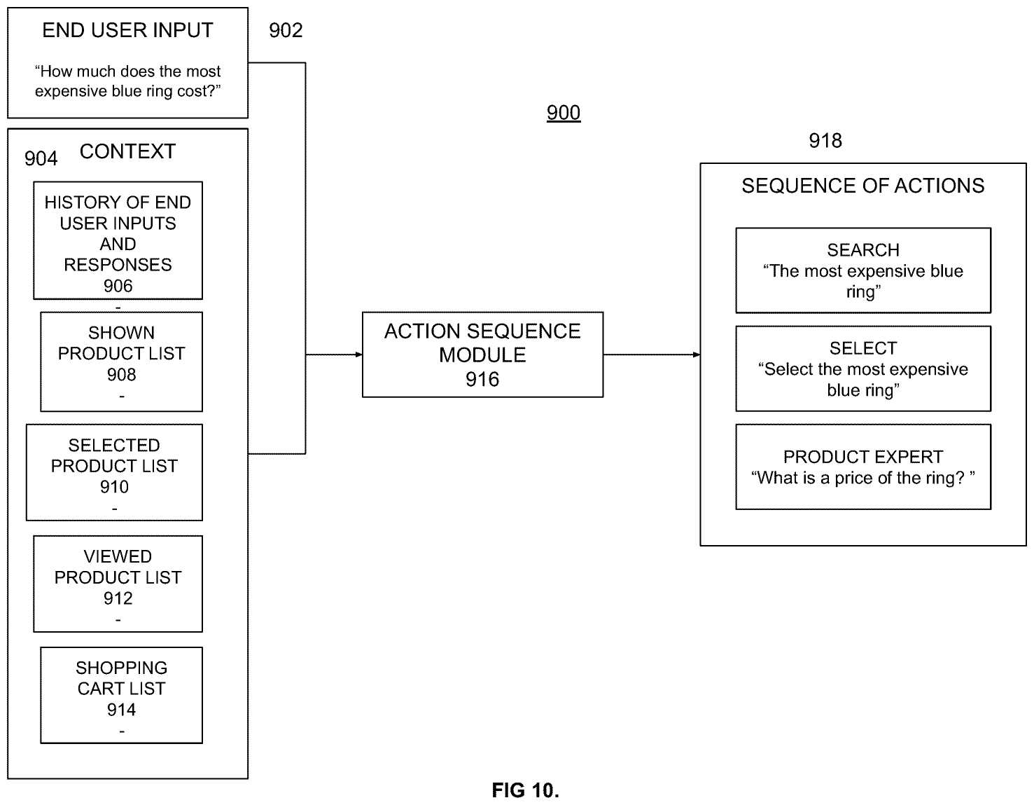

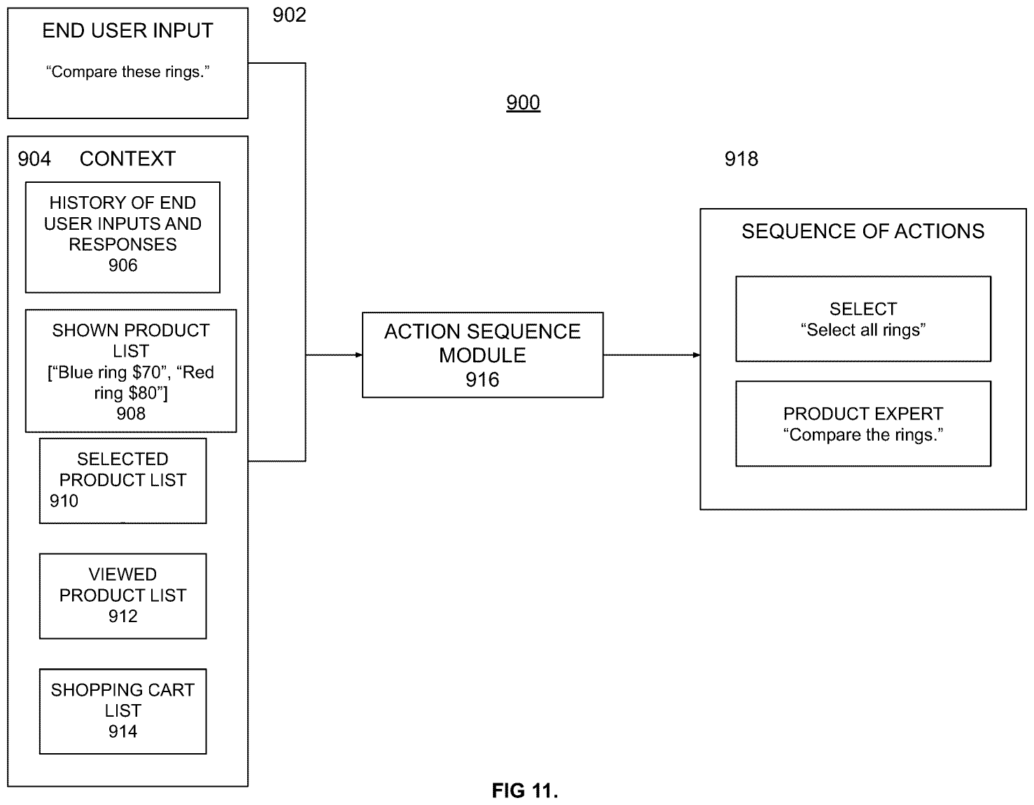

FIG. 8 shows a method 800 in accordance with some embodiments of the present disclosure. In some embodiments, at block 802, the method 800 may include receiving end user input (e.g., 902 in FIG. 9) and receiving context (e.g., 904 in FIG. 9) related to the end user input. As shown in FIG. 9, the context 904 may include at least one of a chronologically ordered list of any preceding end user inputs or responses to preceding end user inputs 906, one or more lists of products that were previously presented to the end user 908, one or more lists of products selected by the end user 910, one or more lists of products viewed by the end user 912, or one or more lists of products added to a shopping cart by the end user 914. For example, FIG. 10 shows an end user input of “How much does the most expensive blue ring cost?”

In some embodiments, and as shown in FIG. 8, at block 804 the method may include combining the end user input and context. At block 806, the method 800 may include passing context and end user input (e.g., the query) to an action sequence module (e.g., action sequence module 916 in FIG. 9). The action sequence module 916 may use a Large Language Model to understand the need described in the end user input 902 and context 904 related to the end user input, and output a sequence of actions and parameters (e.g., sequence of actions and reformulated queries 916 in FIG. 9) associated with the actions that will fulfill the need. For example, as shown in FIG. 10, three actions are shown as a sequence of actions, SEARCH, SELECT, and PRODUCT EXPERT, related to the end user input and related context.

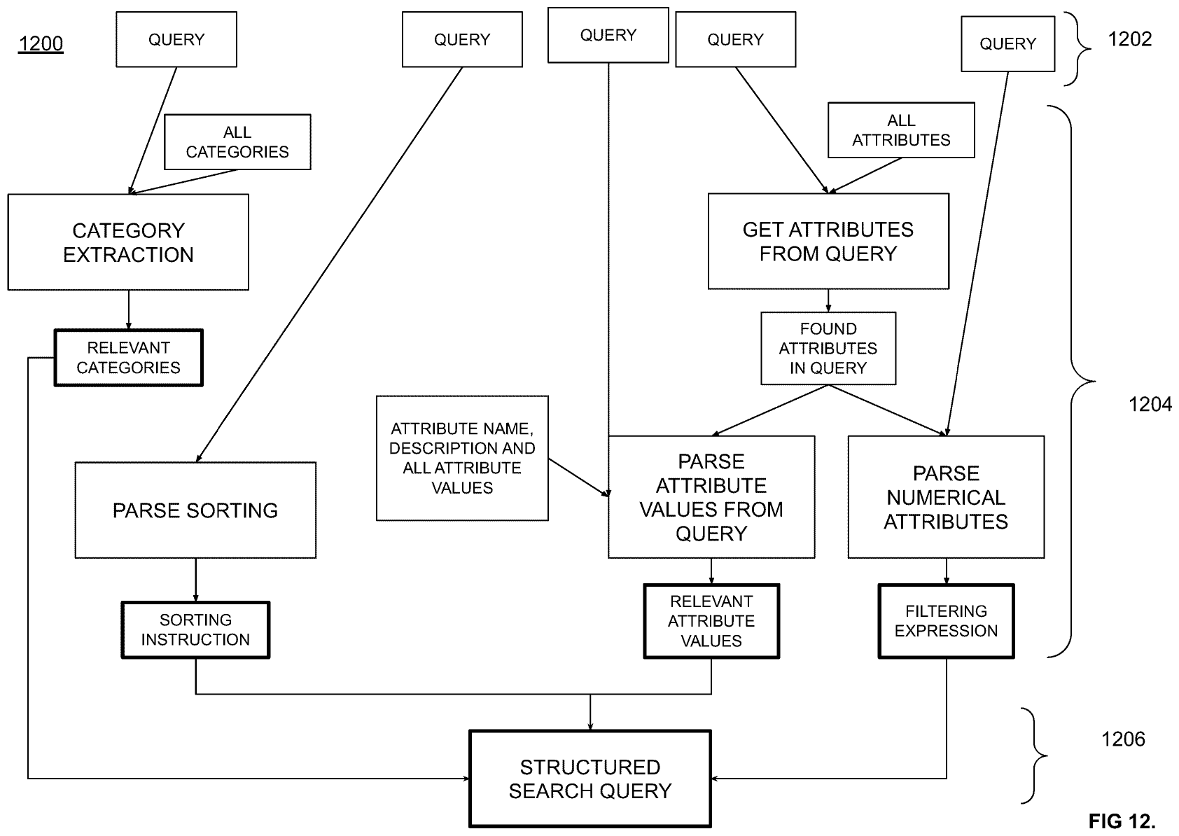

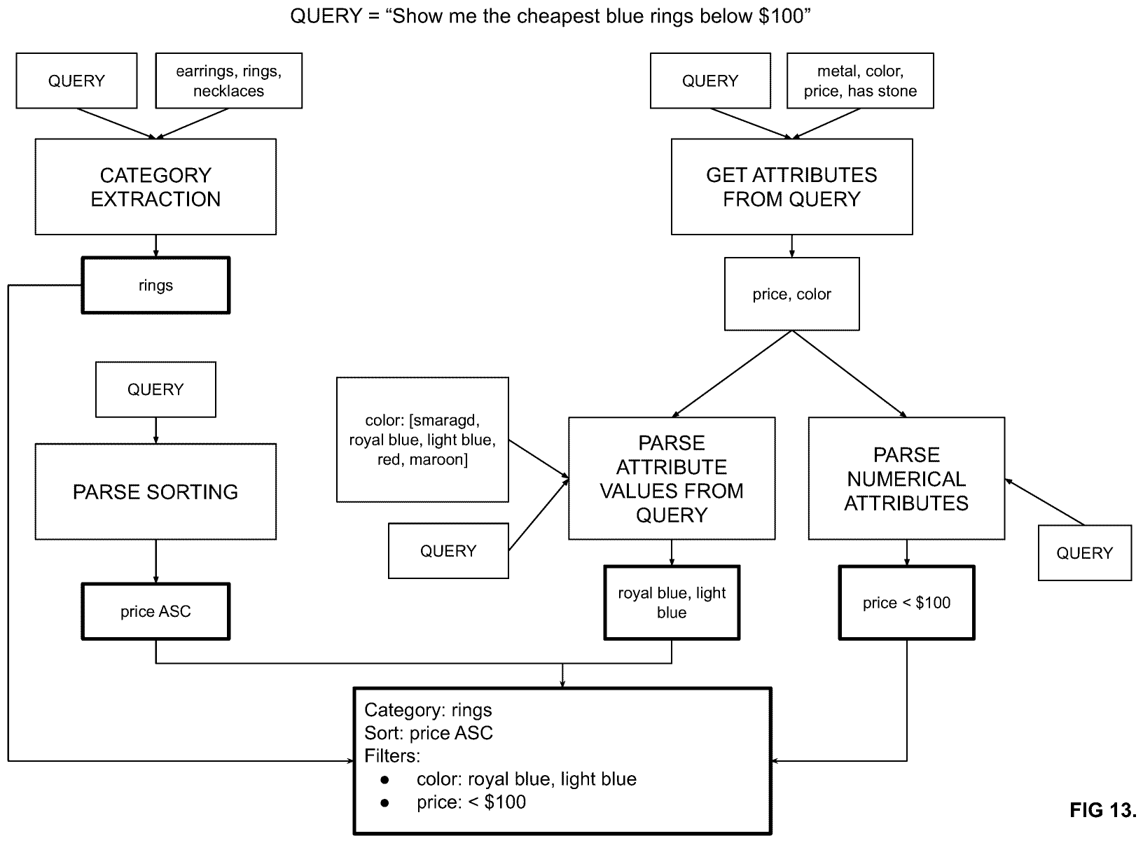

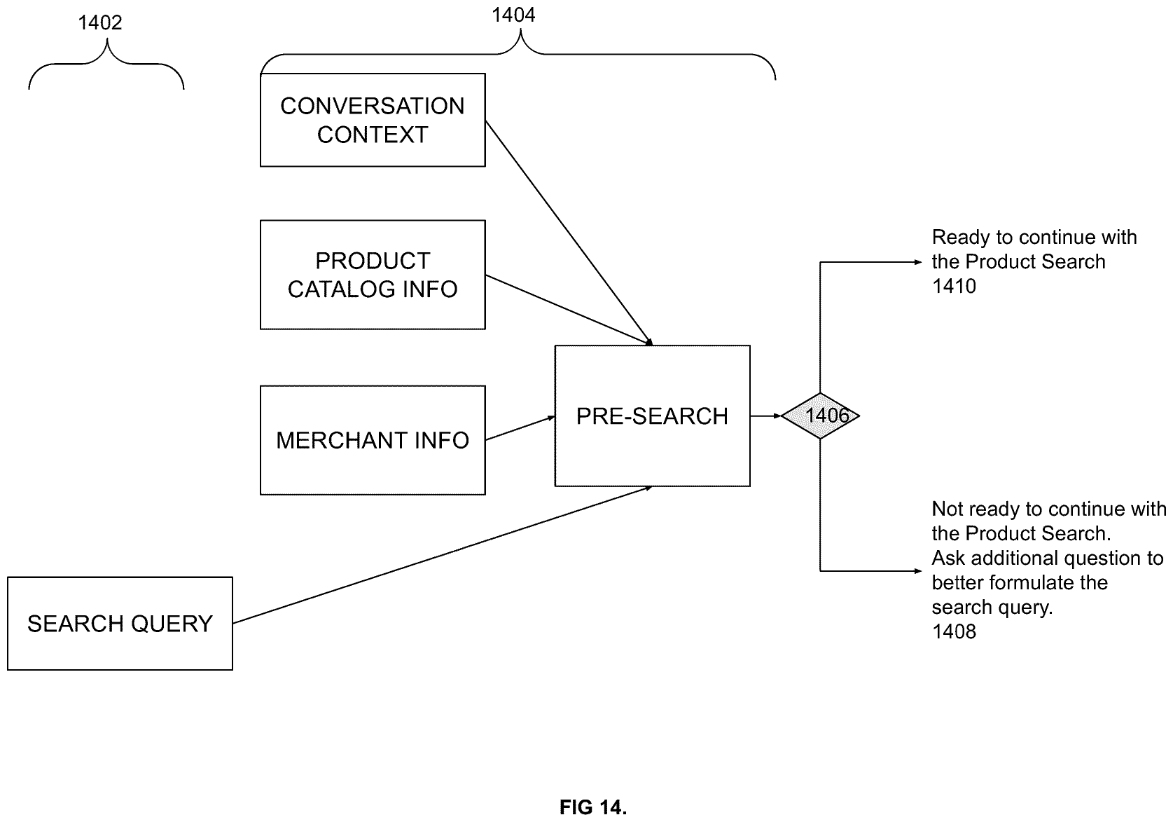

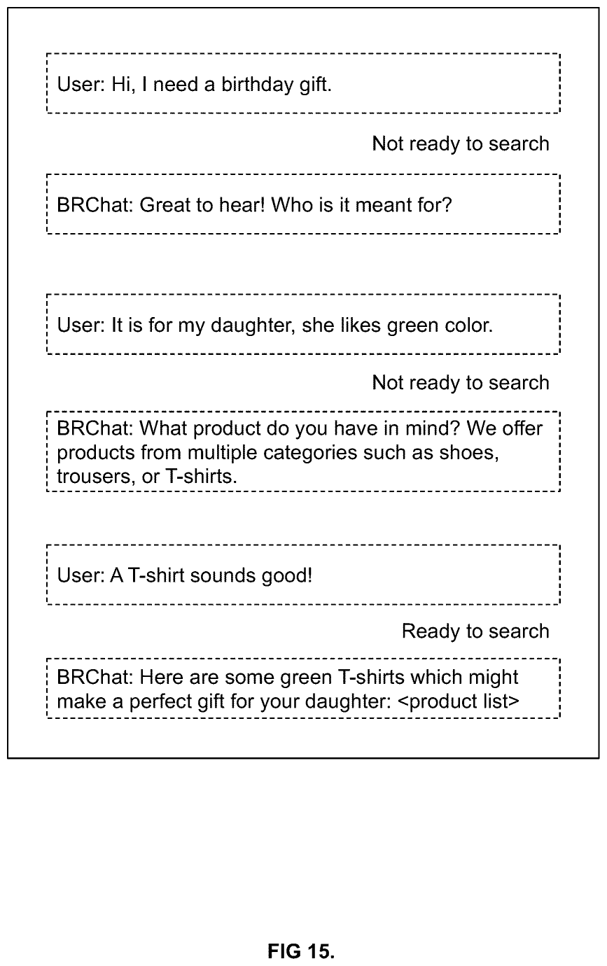

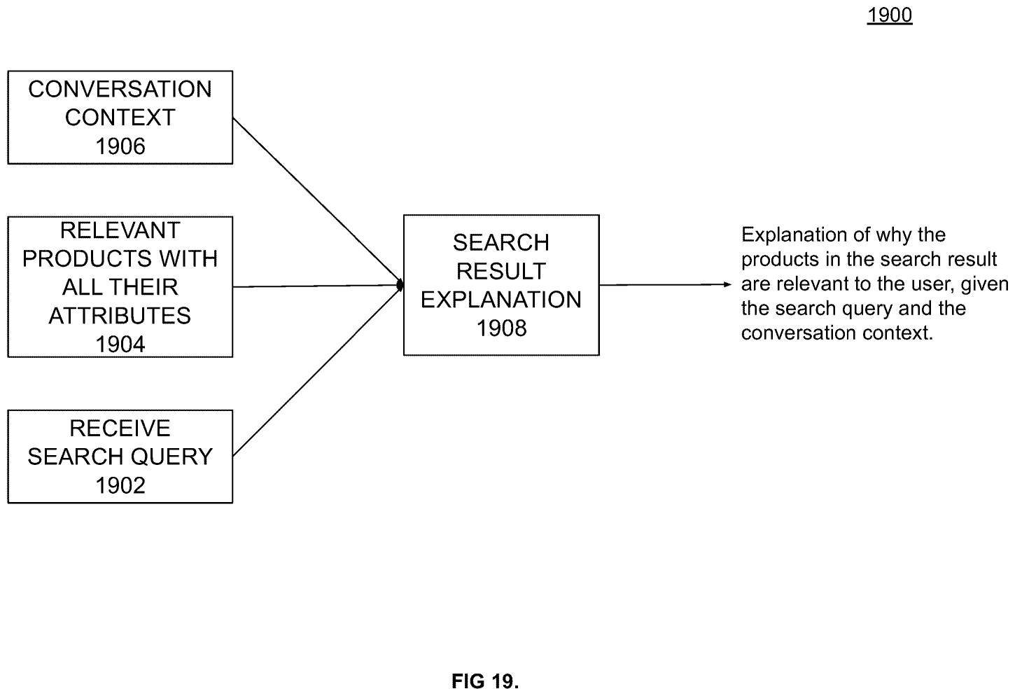

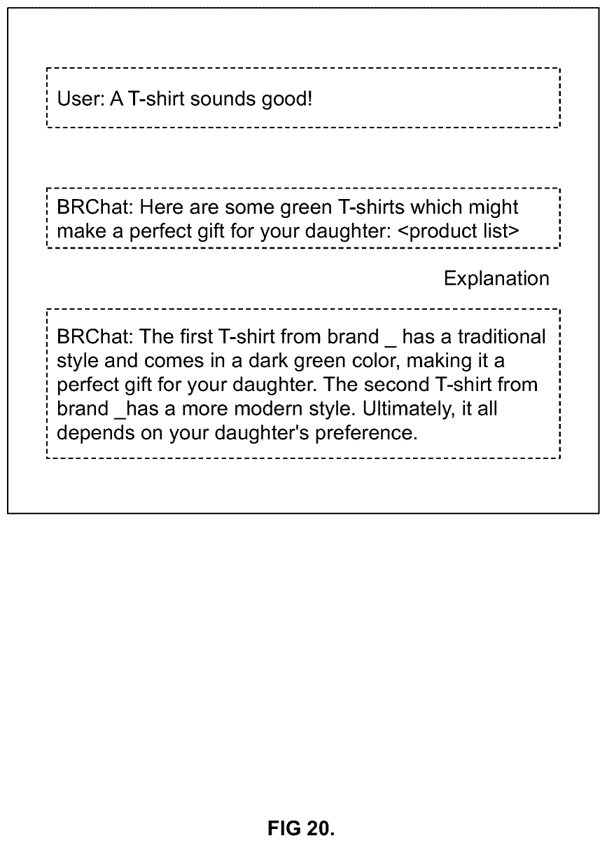

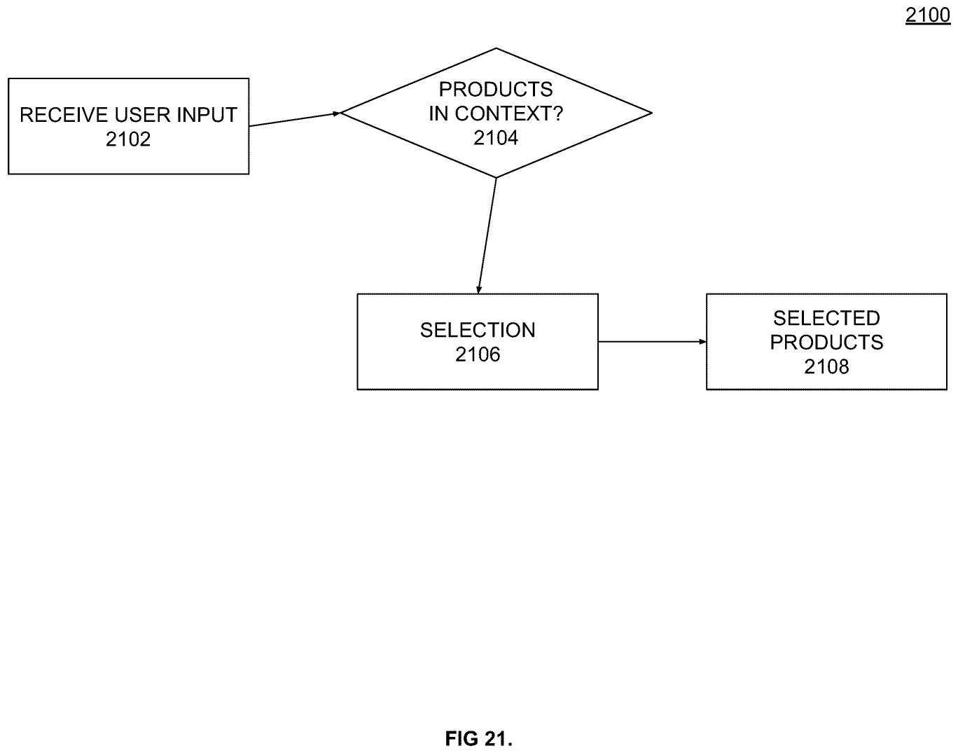

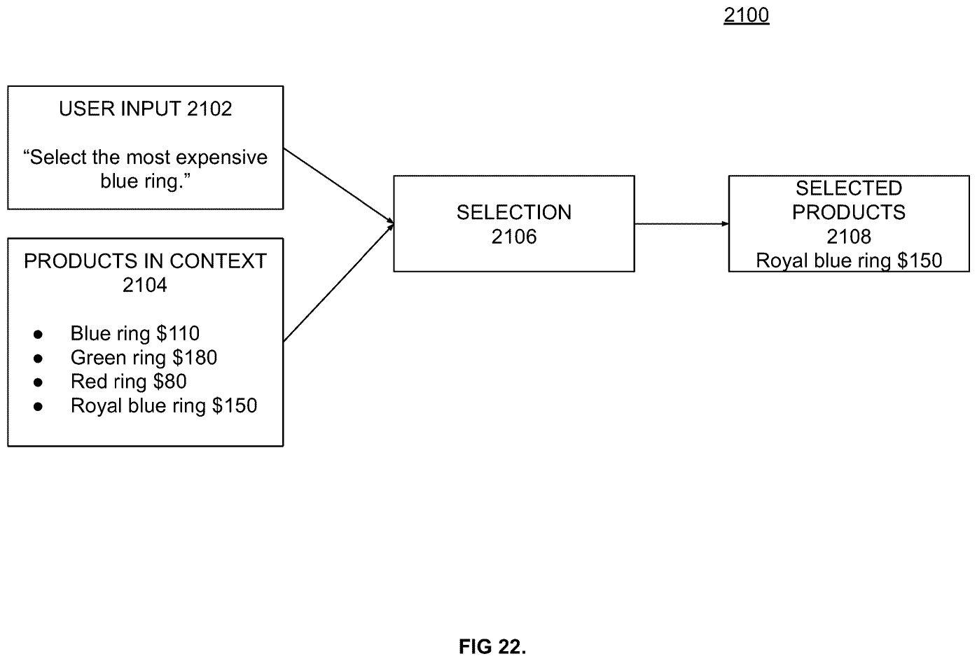

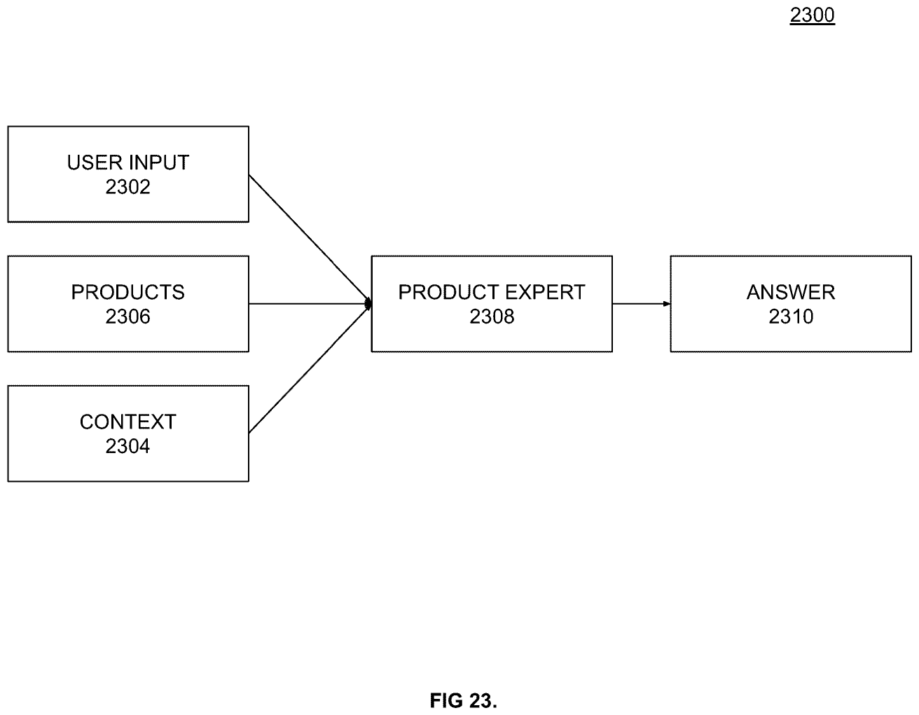

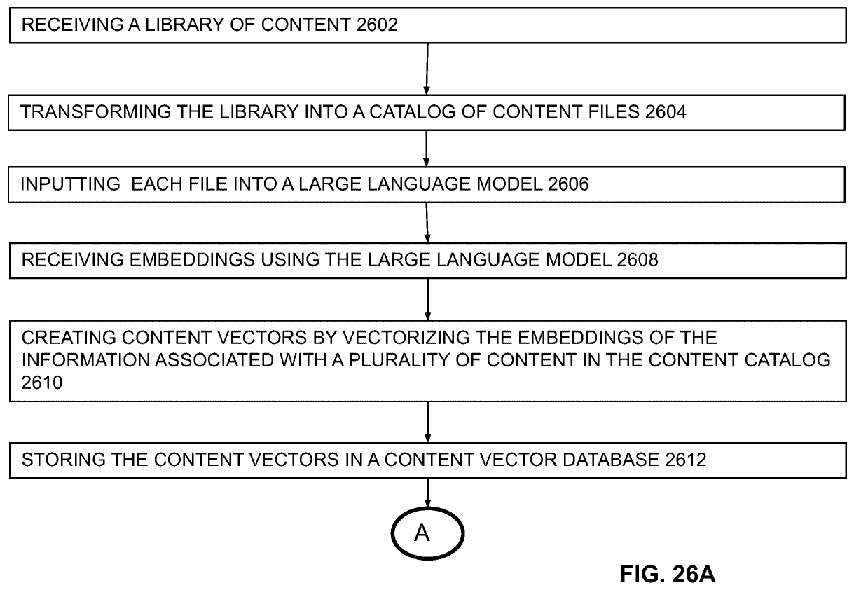

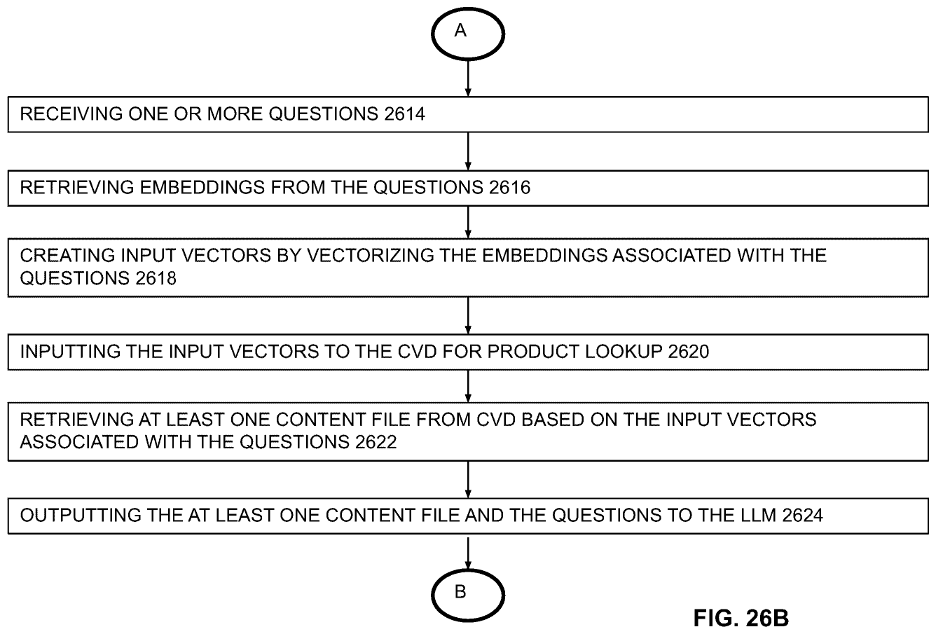

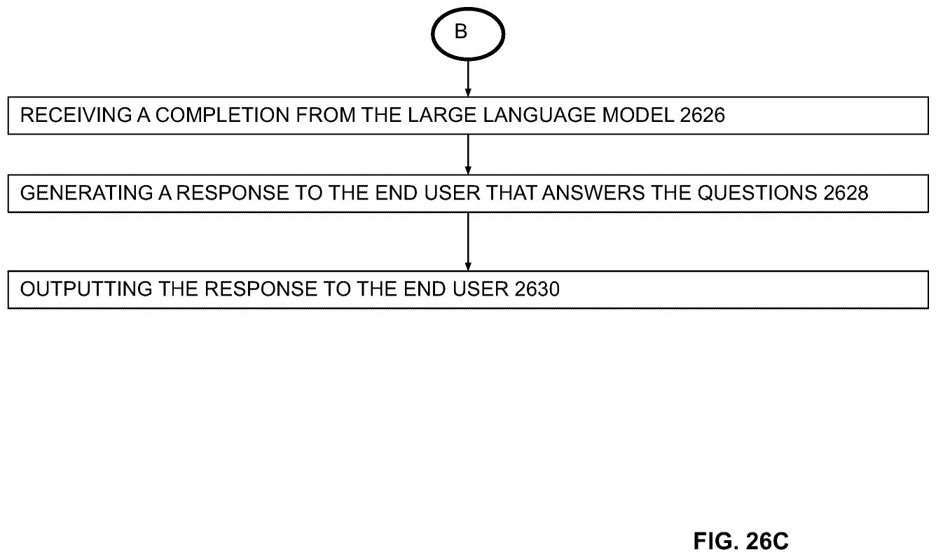

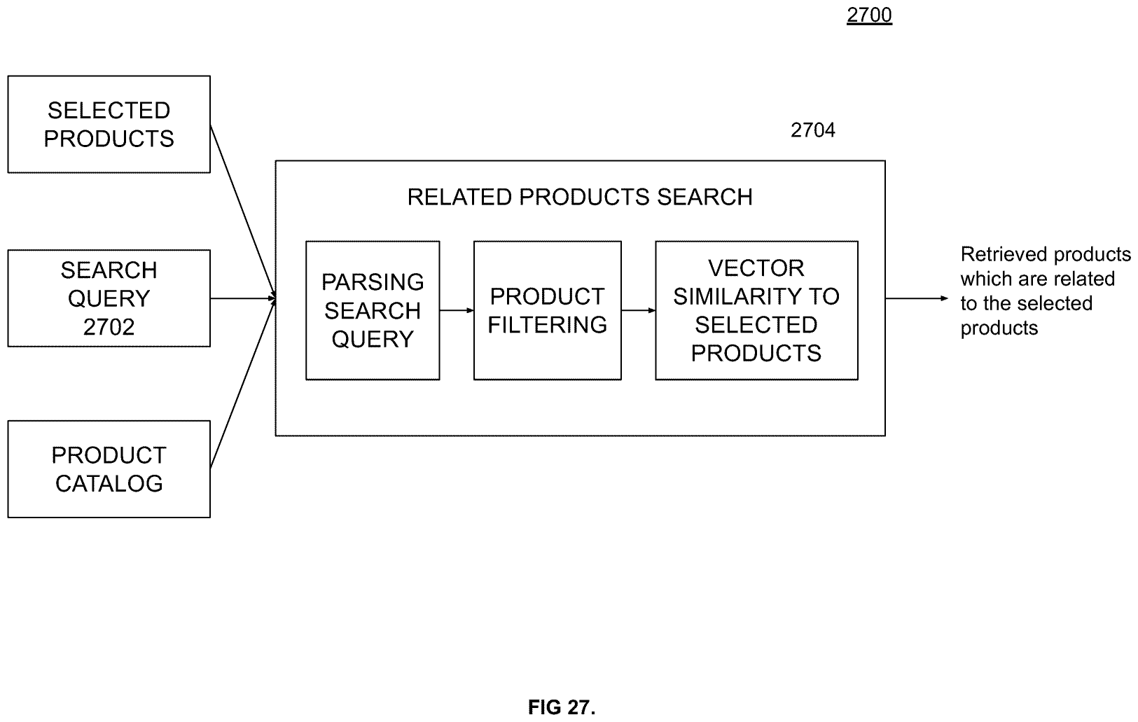

In some embodiments, each action in the sequence of actions 916 is selected by the LLM from a library of available action types. In some embodiments, each action type describes a method to perform a particular task. In some embodiments, and as shown, for example in FIGS. 21 and 22, the library of available action types may include an action type for selecting one or more products of interest referenced in the end user input or context related to the end user input. In some embodiments, and as shown, for example in FIGS. 23, 24, and 25, the library of available action types may include an action type for answering a question about one or more products. In some embodiments, and as shown for example in FIGS. 14 and 15, the library of available action types may include an action type for generating a response to the end user that includes questions to ask the end user to explain their need further. In some embodiments, and as shown in FIGS. 12 and 13, the library of available action types may include an action type for retrieving at least one list of products and information about those products based on a search query. In some embodiments, and as shown in FIGS. 19 and 20, the library of available action types may include an action type for outputting a response to the end user that references at least one of the products in a list of products and may include a description of how at least one of the products addresses the end user's need. In some embodiments, and as shown in FIG. 26, the library of available action types may include an action type for outputting a response when the end user need is not about one or more products. In some embodiments, and as shown in FIG. 27, the library of available action types may include an action type for retrieving at least one list of products that are similar to one or more products and information about each of the retrieved products. In some embodiments, and as shown in FIG. 27, the library of available action types may include an action type for retrieving at least one list of products that are related in a given way to one or more products.

At block 808, the method 800 may include receiving valid sequence of actions along with a rephrased query for every action. For example, in FIG. 10, the sequence of actions 916 shows three actions each with a rephrased query the end user may receive, such as via a display visible to an end user.

FIG. 12 shows a method 1200 of parsing a search query from the end user in accordance with some aspects of the present disclosure. FIG. 13 depicts an example of performing the method 1200. At block 1202, the method 1200 may include receiving a search query from an end user. At block 1204, the method 1200 may include outputting the query and categories values, attributes name, attribute description, and attribute values in the relevant catalog to a Large Language Model. At block 1206, the method 1200 may include receiving completions from the Large Language model that generate a structured search query that includes filtering expression, relevant attribute values, and sorting instruction. FIG. 13 shows an example of using the method 1200 in response to an end user query of “Show me the cheapest blue rings below $100.”

FIG. 14 shows a method 1400 in accordance with some aspects of the present disclosure. FIG. 15 depicts an example of performing the method 1400. At block 1402, the method 1400 may include receiving search query from the end user. At block 1404 the method 1400 may include outputting the search query, the conversation context, product catalog info, and merchant info to a Large Language Model, and receiving a completion that determines if enough information is available to search for relevant products to show to the end user. At block 1406, the method 1400 may include determining whether enough information is available to search for relevant products to show to the end user. At block 1408, if it is determined that not enough information is available to search for relevant products to show to the end user, the method 1400 may include generating an appropriate question to ask the end user to guide them to provide more such information about what kind of products they are looking for. Otherwise, at block 1410, if it is determined that enough information is available to search for relevant products to show to the end user, the method 1400 may proceed with the product search. For example, in the exchange shown in FIG. 15, a determination is made twice that not enough information has been received to perform a search. However, when it is determined that enough information is received, a search proceeds and returns search results to the end user.

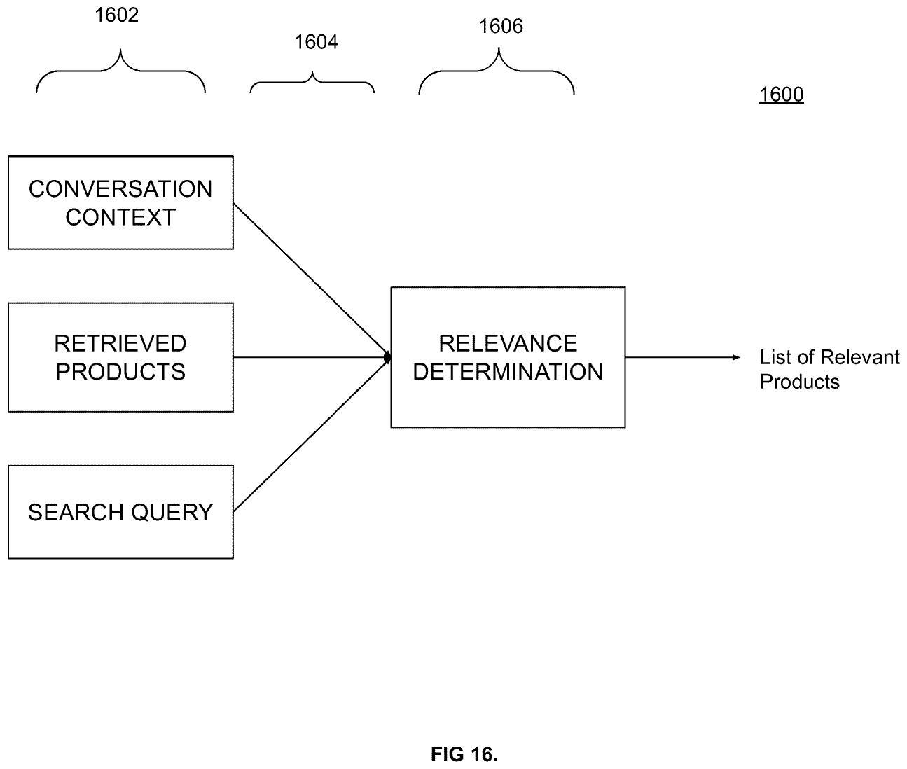

FIG. 16 shows a method 1600 in accordance with some embodiments of the present disclosure. At block 1602, the method 1600 may include receiving at least one of input from an end user, or receiving context related to the end user input that includes a chronologically ordered list of any preceding end user inputs or responses to preceding end user inputs, and one or more lists of products that were previously presented to the end user, viewed by the end user, added to a shopping cart by the end user, or selected by the end user, or receiving a search query for products. At block 1604, the method 1600 may include receiving an ordered list of products that match the search query. At block 1606, the method 1600 may include outputting some or all of the above end user input, context, search query and ordered list of products to a Large Language Model, and receiving a completion from the Large Language model that transforms the ordered product list into a new ordered list of products where the order of a product in the list corresponds to the relevance of the product to the search query.

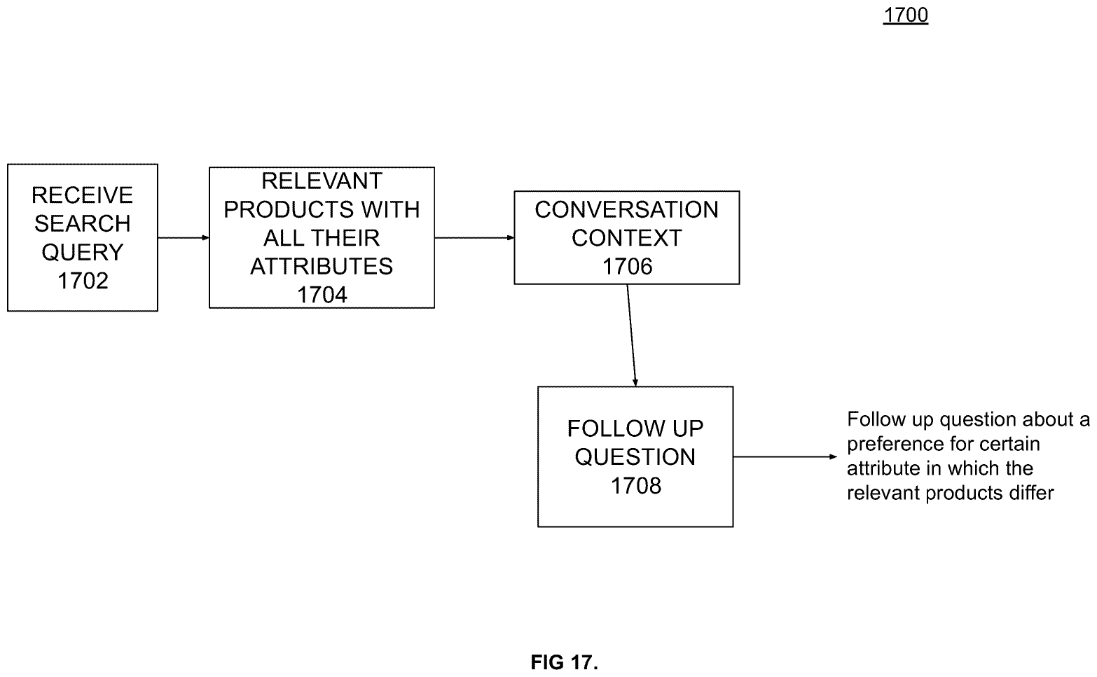

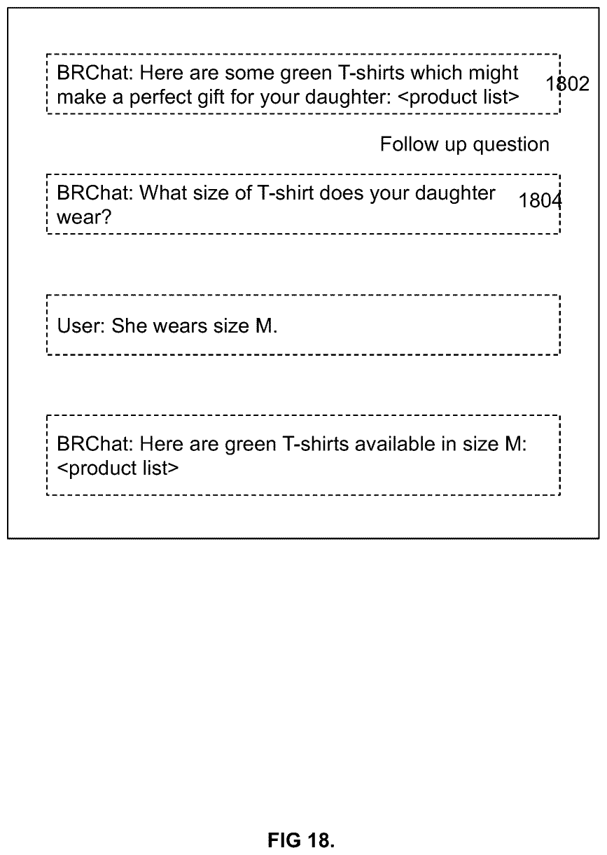

FIG. 17 shows a method 1700 in accordance with some embodiments of the present disclosure. FIG. 18 depicts an example of performing the method 1700. At block 1702, the method 1700 may include receiving search query from the end user. At block 1704, the method 1700 may include responding with products relevant to the search query and all available context. For example, at 1802, the user is presented with a list of relevant products. At block 1706, the method 1700 may include outputting the conversation context, the relevant products (shown) along with all their attribute info to a Large Language Model. At block 1708, the method may include receiving a completion that generates relevant questions to ask the end user in order to further refine the list of products shown to the end user in response to their search inquiry. For example, at 1804, the user is presented with a follow up question.

FIG. 19 shows a method 1900 in accordance with some embodiments of the present disclosure. FIG. 20 depicts an example of performing the method 1900. At block 1902, the method 1900 may include receiving search query from the end user. At block 1904, the method 1900 may include responding with products relevant to the search query and all available context 1906. At block 1908, the method 1900 may include outputting the conversation context, the relevant products (shown) along with all their attribute info to a Large Language Model, and receiving a completion that generates relevant explanations to show to the end user in order to explain the reasoning of why the shown product results were shown to the end user. For example, in FIG. 20, the end user is presented with an explanation regarding T-shirts shown to the end user.

FIG. 21 shows a method 2100 in accordance with some embodiments of the present disclosure. FIG. 22 depicts an example of performing the method 2100. At block 2102, the method 2100 may include receiving user input from an end user. At block 2104, it is determined whether the end user is seeking to ask certain questions about certain products from their context. At block 2106, if it is determined that the end user is seeking to ask certain questions about certain products from their context, the method 2100 outputs the user input and products in context to a Large Language Model, and at block 2108, receives a completion that determines which product(s) the end user is intending to ask their questions about.

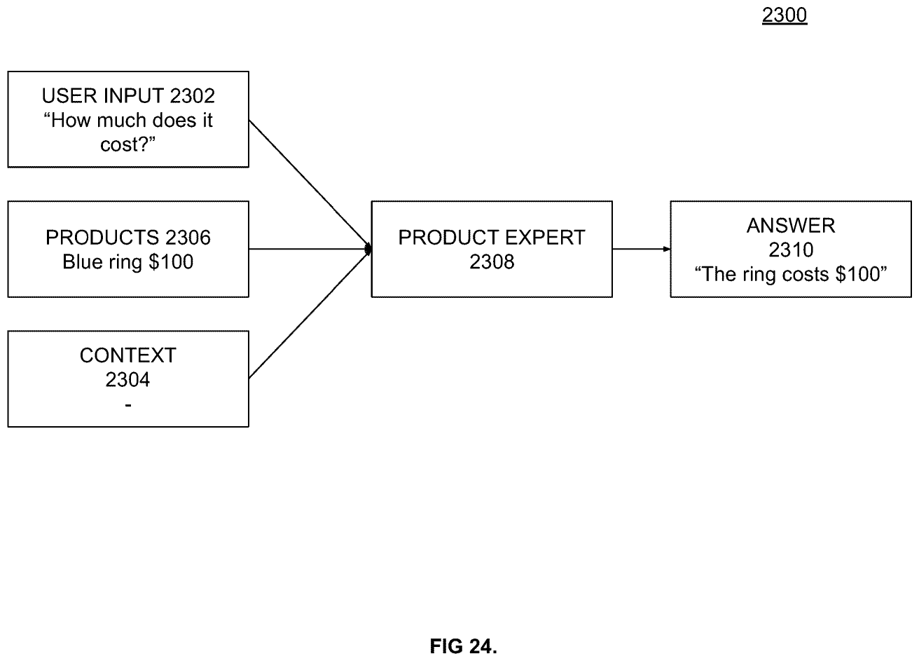

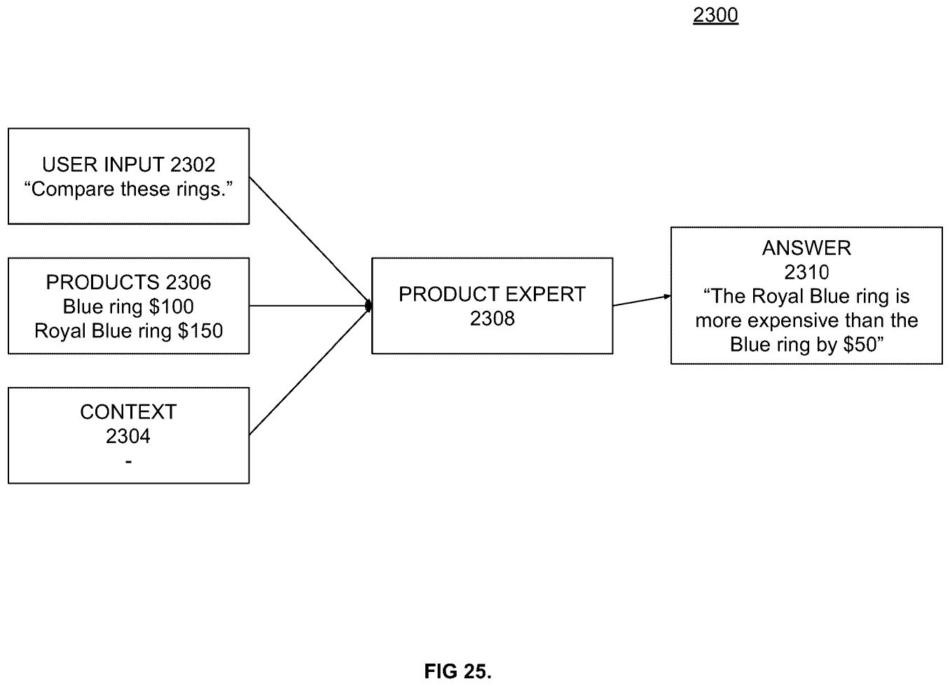

FIG. 23 shows a method 2300 in accordance with some embodiments of the present disclosure. FIGS. 24 and 25 depict examples of performing the method 2300. At block 2302, the method 2300 may include receiving input from an end user. For example, in FIG. 24, the user input is a query “How much does it cost?” and in FIG. 25, the user input is a request to “Compare these rings.” At block 2304, the method 2300 may include receiving context related to the end user input that includes a chronologically ordered list of any preceding end user inputs or responses to preceding end user inputs, and one or more lists of products that were previously presented to the end user, viewed by the end user, added to a shopping cart by the end user, or selected by the end user; receiving one or more product-related questions. At block 2306, the method 2300 may include receiving a list of products that the product-related questions reference and information about those products. For example, in FIG. 24, a product “Blue ring $100” is received that relates to the user input and in FIG. 25, two products “Blue ring $100 Royal Blue ring $150” are received that relate to the user input. At block 2308, the method 2300 may include outputting some or all of the above end user input, context, questions, referenced products and their information to a Large Language Model, and receiving a completion from the Large Language model. At block 2310, the method 2300 may include generating a response to the end user that answers the questions by including information about the referenced products; and outputting the response to the end user. For example, in FIG. 24, the method outputs a response “The ring costs $100” and in FIG. 25, the method outputs a response “The Royal Blue ring is more expensive than the Blue ring by $50.”

FIGS. 26A-26C show a method 2600 in accordance with some embodiments of the present disclosure. At block 2602, the method 2600 may include receiving a library of content. At block 2604, the method 2600 may include transforming the library into a catalog of content files. At block 2606, the method 2600 may include inputting each file into a large language model. At block 2608, the method 2600 may include receiving embeddings from the large language model. At block 2610, the method 2600 may include vectorizing the embeddings. At block 2612, the method may include storing vectors in a content vector database.

At block 2614, the method 2600 may include receiving one or more questions. At block 2616, the method 2600 may include retrieving embeddings for the questions. At block 2618, the method 2600 may include vectorizing the embeddings associated with the questions. At block 2620, the method 2600 may include inputting the vectors to the content vector database for content look up. At block 2622, the method 2600 may include retrieving one or more retrieved content files from the content vector database. At block 2624, the method 2600 may include outputting questions and retrieved content files to a Large Language Model.

At block 2626, the method 2600 may include receiving a completion from the Large Language model. At block 2628, the method 2600 may include generating a response to the end user that answers the questions. At block 2630, the method may include outputting the response to the end user.

FIG. 27 shows a method 2700 in accordance with some embodiments of the present disclosure. At block 2702, the method 2700 may include receiving a search query from an end user. At block 2704, if it is determined that the end user is seeking to search for products that are related to one or more of the previously selected products in end user's context, that are related either in a general way, or in some specific way(s) (e.g. price, color, shape, complementary, accessory etc.), then using the search query, selected products and an embeddings-based vector search on the available product catalog (and possibly an LLM model), are used to determine the relevant products to show to the end user.

1. A method of customer engagement comprising:
receiving a product catalog including information associated with a plurality of products;
encoding product data by at least one of generating a reverse text index associated with a plurality of products in the product catalog or vectorizing embeddings of the information associated with the plurality of products in the product catalog;
storing the encoded product data in a product catalog database;
receiving input from an end user;
at least one of converting the end user input to a text query or creating input vectors by vectorizing embeddings associated with the input;
retrieving at least one list of products from the product catalog database based on at least one of the text query or the input vectors associated with the input; and
outputting a response to the end user, wherein the response includes a selectable link to product information of products of the at least one list of products.

2. The method of claim 1, further comprising:
performing transforms on the product catalog;
inputting the transforms into a large language model; and
receiving embeddings of the information associated with a plurality of products in the product catalog from the large language model.

3. The method of claim 1, further comprising:
outputting the at least one list of products to a large language model;
receiving a completion from the large language model; and
generating the response.

4. A non-transitory computer readable medium, storing thereon computer readable instructions that when read by a computer cause a processor to perform a customer engagement method comprising:
receiving a product catalog including information associated with a plurality of products;
encoding product data by at least one of generating a reverse text index associated with a plurality of products in the product catalog or vectorizing embeddings of the information associated with the plurality of products in the product catalog;
storing the encoded product data in a product catalog database;
receiving input from an end user;
at least one of converting the end user input to a text query or creating input vectors by vectorizing embeddings associated with the input;
retrieving at least one list of products from the product catalog database based on at least one of the text query or the input vectors associated with the input; and
outputting a response to the end user, wherein the response includes a selectable link to product information of products of the at least one list of products.

5. The non-transitory computer readable medium of claim 4, further comprising:
performing transforms on the product catalog;
inputting the transforms into a large language model; and
receiving embeddings of the information associated with a plurality of products in the product catalog from the large language model.

6. The non-transitory computer readable medium of claim 4, further comprising:
outputting the at least one list of products to a large language model;
receiving a completion from the large language model; and
generating the response.

7. A system for customer engagement comprising:
a processor configured to:
receive a product catalog including information associated with a plurality of products;
encode product data by at least one of generating a reverse text index associated with a plurality of products in the product catalog or vectorize embeddings of the information associated with the plurality of products in the product catalog;
store the encoded product data in a product catalog database;
receive input from an end user;
at least one of convert the end user input to a text query or create input vectors by vectorizing embeddings associated with the input;
retrieve at least one list of products from the product catalog database based on at least one of the text query or the input vectors associated with the input; and
output a response to the end user, wherein the response includes a selectable link to product information of products of the at least one list of products.

8. The system of claim 7, further comprising:
perform transforms on the product catalog;
input the transforms into a large language model; and
receive embeddings of the information associated with a plurality of products in the product catalog from the large language model.

9. The system of claim 7, further comprising:
output the at least one list of products to a large language model;
receive a completion from the large language model; and
generate the response.

10. (canceled)
